(19) United States
(12) Patent Application Publication
(10) Pub. No.: US 2019/0018850 A1
(43) Pub. Date: Jan. 17, 2019

(54) SYSTEMS AND METHODS FOR ASSET MAINTENANCE MANAGEMENT

(71) Applicant: 1SpotTech, Inc., Plymouth, MN (US)

(72) Inventors: Steve Bartz, Medina, MN (US); Rich Byrne, Minneapolis, MN (US); Scott Jacobson, Bloomington, MN (US); Oliver Papp, Minnetonka, MN (US)

(21) Appl. No.: 16/034,756

(22) Filed: Jul. 13, 2018

Related U.S. Application Data
(60) Provisional application No. 62/532,136, filed on Jul. 13, 2017.

(51) Int. Cl. G06F 17/30; G06Q 50/16; G06F 3/0484

(52) U.S. Cl. CPC G06F 17/3056; G06F 17/30572; G06F 3/0483; G06F 3/04847; G06Q 50/163

(57) ABSTRACT

Systems and methods for visually collecting, organizing, storing and accessing information. Users can visually track information related to facilities and physical assets. Systems and methods allow users to collect and manage information for other types of objects that require the physical locations of points to data elements. Further, systems provide an organized information repository for data. Systems provide individualized or tailored communications capability between users regarding the stored data or transactions about the stored data.

### PRIORITY

This application claims the benefit of and priority to U.S. Provisional Application No. 62/532,136, filed Jul. 13, 2017, the entire contents of which is incorporated herein by reference.

### TECHNICAL FIELD

Embodiments relate generally to systems and methods for collecting and managing data and, more particularly, for systems and methods for visually collecting and managing property data.

### BACKGROUND

Traditionally, data in a particular industry is stored specific to the fields and data of that industry. For example, commercial property data might be stored in a relational database with address, property size, and GPS location. In the commercial trucking industry, truck data might be stored in a record structure with truck name, license plate, and driver information. Plainly, commercial property data and commercial trucking data do not seemingly have much overlap in data.

As a result, data storage and access systems are typically tailored specific to those industries. However, such systems lack the flexibility required by users. Users must often match up their data one-to-one with the particular data fields required by that industry in order to input the data into the system. This rigidity in data field matching is generally time-consuming for users and often leads to user frustration.

Moreover, the traditional commercial property data system cannot be used in a commercial trucking data application, and vice versa. Therefore, individualized, incompatible software and systems are typically devised for each industry, leading to myriad industry-specific systems on which users must operate. This generation of multiple industry-specific systems is inefficient, not to mention the burden on users, for example, switching jobs between industries.

Further, traditional data repositories do not allow for individualized communication capabilities, such as those between users about the data being stored.

### SUMMARY

Embodiments described herein meet the aforementioned needs of the industry. In embodiments, systems and methods allow users to visually collect, organize, store, and access information. In an embodiment, systems and methods allow users to visually track information related to facilities and physical assets. In other embodiments, systems and methods allow users to collect and manage information for other types of objects that require the physical locations of points to data elements.

Embodiments provide a visual organization of the data that allows the user to see patterns that might be difficult to identify without such visual representation. For example, the clustering of a large number of problem points in a particular area of a property can reveal an underlying structural or systematic issue that otherwise would not be easy to identify.

In a feature and advantage of embodiments, systems provide an organized information repository for data. For example, data can be stored according to various data containers and organized at any number of levels. Data can be generalized as objects such that no particular fields or data types are required, or data can be tailored according to particular types of data and the industry. Embodiments therefore allow for the flexibility of data input over existing solutions. For example, no matter the industry, embodiments provide a visualization of an image, a point on the image, and a visual file cabinet to hold data related to that point. This is in contrast to existing solutions that offer individualized software and systems specific to each industry.

In another feature and advantage of embodiments, systems provide individualized or tailored communications capability between users regarding the stored data or transactions about the stored data. For example, an owner of a property can communicate with a contractor using the system about repairing a portion of the property, wherein the stored data is related to portion of the property to be repaired. In this example, the property owner may have access to all of the data related to the property, and the contractor may have access to only the portion of the property to be repaired.

Embodiments allow workers, managers, property managers, and owners to quickly see and communicate the full scope and details of bid requests, proposed projects, work-in-process, change orders and completed jobs. Notifications and screen displays provide quick access to status and one-click drill downs to the details of work under consideration. Embodiments are adaptable to all types of work; for example, work with predefined scope or work identified while on site including: one-time jobs, regularly scheduled service, service documentation, inspections, precondition documentation and more.

In a property manager-contractor application, embodiments provide myriad benefits to property managers. In general, property managers using embodiments of the system and methods are more productive. For example, contractors can enter property management information for the property manager. As a result, the property manager no longer needs to enter this information. In embodiments, for ease of explanation, a “property manager” is described in embodiments herein. However, benefits of the embodiments described herein can also apply to facility managers that also deal with contractors. One skilled in the art will readily appreciate that in certain contexts, the property manager label is interchangeable with facility manager, in embodiments.

In addition to being more productive, property managers are better informed for on-the-spot questions and monthly reporting, allowing the property manager to cement his relationship with owners and tenants.

In another advantage, a property manager in his office or walking on the property can get a quick look at who is on the property and what they are working on. Embodiments allow the property manager to see recent updates on specific jobs and review change order requests. When needed, the property manager can drill down to see specific details of a job. Further, the property manager can create and assign jobs for issues spotted while walking the property.

In another advantage for the property manager, time managing maintenance and construction projects is reduced. Embodiments provide clear visual communication of what needs to be done and where it needs to be done, thereby eliminating confusion. Small jobs can be documented and assign in real time as the property manager sees them. Embodiments provide real-time alerts for jobs that need attention. Embodiments further allow the property manager to document the value of his best contractors. Further, contractor bids can be easily and quickly compared in an apples-to-apples comparison. Embodiments further decrease the risk of using a new vendor, as the vendor is required to document the work in process. Moreover, all interested parties use the platform for updates, instead of only the property manager.

In another advantage for the property manager, fewer on-site meetings are needed. Embodiments allow bid request meetings to be conducted remotely. Further, quick real-time change order communication is fully and effortlessly documented. Embodiments further allow for the remote inspection of completed jobs. A “Universal Activity Stream” allows the property manager (or facility manager) to see all recent activity on all of their respective properties easily on one screen. The continuous feed of activities provided by the Universal Activity Stream allows the manager to monitor all properties efficiently and to catch up on activities that occurred during any time period.

In another advantage for the property manager, comprehensive reports provide valuable summary information. For example, the property manager can generate a report documenting what every staff member, vendor, and contractor is doing. Further, embodiments can readily provide a report of what is proposed, approved, and in-process, by property and tenant, thereby easing scheduling and budgeting.

In another advantage for the property manager, proposed budgets can be quickly prepared and approved. A quick view for remote managers/owners allow the property manager to see exactly what is proposed and why it is proposed. Embodiments allow filtering of budget request by priority or necessity.

In another advantage for the property manager, verification of critical steps during the process (such as a repair process) ensures that the job was done right. This methodology further promotes best practices in the industry.

In another advantage for the property manager, embodiments allow the property manager to save money. For example, traditionally, less than 10% of warranties are reviewed. Embodiments allow for warrantee recovery, or particularly, the ability to access historical information about a job to recover the warranty. Embodiments further promote fraud prevention. New contractors are “showing their work” by documenting the job with photos and comments.

Embodiments further provide a number of benefits for the contractor in a property manager-contractor application. For example, the contractor can save time and cost. Fewer on-site meetings with property managers and employees are required when using embodiments. Sub-contractors and employees can be more easily managed by the provided visibility in reports and dashboards. Embodiments allow for the pre-existing damage documentation, which traditionally is time consuming and often not conducted. Further, new employees can be quickly trained by requiring key step verification. Likewise, verification of critical steps during the process ensures best practices and quality, thus increasing the value of the contractor to the property manager. Embodiments further eliminate confusion about scope and details of the job.

Contractors also see increased revenue with the use of embodiments. For example, an increase in the acceptance of change orders is attained while the work is being done. Embodiments allow for contractors to acquire new clients by proactively presenting scope of work on a property (which can be categorized by priority). Contractors can utilize embodiments to sell additional services while on site, as well as to expose unqualified competitors and demonstrate points of differentiation by providing visual documentation and explanation during the bidding process, and to demonstrate high quality work by providing visual documentation and explanation while work is being performed

The employee or repair worker further benefits from embodiments. The repair worker can quickly understand where and what needs to be done. This eliminates confusion about scope and details of the job. Embodiments provide for quickly and clear communication about issues, problems, and change orders. Perhaps most important to the worker, he can easily get credit for all work completed by documentation additions provided by embodiments, down to even the smallest details of work. Embodiments further allow the employee to demonstrate his quality of work and commitment to the process.

Similarly, in the property manager-contractor application, embodiments provide numerous benefits to property management entities. Executives of the property management entity are provided more control than traditional solutions. Embodiments allow property management entity executives to quickly view information that to make faster and more-informed decisions, and even from a remote location. For example, the executive might deal with problems such as whether a tenant is picky or whether the property manager is not properly managing his vendors. Embodiments provide data to answer those questions. Embodiments further allow property management entities to save money. For example, fewer property managers are needed, as each property manager can manage more properties. Further, embodiments provide a quick ramp-up for new property managers, as the industry has high turnover.

Additionally, embodiments provide numerous benefits to property owners. For example, embodiments allow the property owner to preserve his property value. Embodiments ease the transition of taking over a new property. Further, a higher selling price is often dictated by being able to show or demonstrate the history of care for a property, which is provided by embodiments. The property owner further can better control his costs. For example, informed budgeting process can be done quickly without leaving the office. As described with respect to the property manager benefits, the property can be visually inspected without travel costs. In general, the overall status of a property and costs of repair can be viewed remotely, for banking, budgeting, and tax assessment purposes. Moreover, embodiments allow the property owner to save money. Management continuity is maintained when there is staff turnover. Embodiments can further reduce the cost of managing a property, recovered warranty costs, and prevent fraud, as described with respect to the property manager benefits.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a visual filing cabinet system, according to an embodiment.

FIG. 2 is a block diagram of a visual filing cabinet data structure, according to an embodiment.

FIG. 3 is a block diagram of a visual filing cabinet data structure for a real property application, according to an embodiment.

FIG. 4 is a flowchart of a method for managing a visual filing cabinet system, such as the visual filing cabinet system of FIG. 1, according to an embodiment.

FIG. 5 is a flowchart of a method for visually managing property management data, according to an embodiment.

FIG. 6 is a flowchart of another method for visually managing property management data with points, according to an embodiment.

FIG. 7 is a diagram of an example work flow between users of the system, according to an embodiment.

FIG. 8A is a diagram of a job point for various users of the system, according to an embodiment.

FIG. 8B is a diagram of a job point including prompts to a sub-contractor for passing information, according to an embodiment.

FIGS. 9A-9N are screenshots of a visual filing cabinet system for a workflow of a property manager checking on a job status, according to an embodiment.

FIGS. 10A-10X are screenshots of a visual filing cabinet system for a workflow of a property manager walking the property and adding a job.

FIGS. 11A-11AA are screenshots of a visual filing cabinet system for a property manager and contractor interaction workflow, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

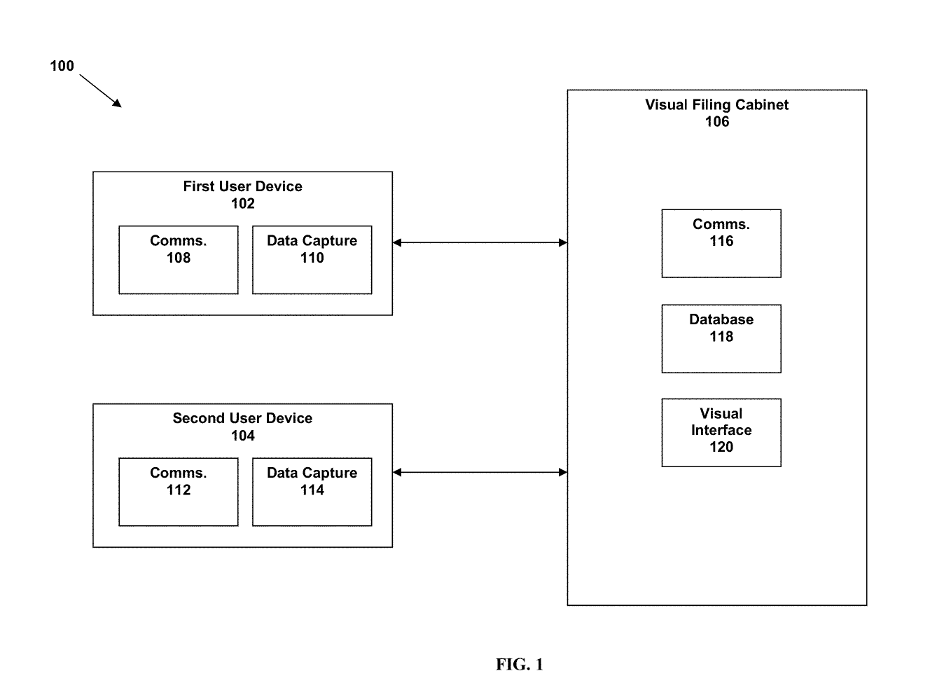

Referring to FIG. 1, a block diagram of a visual filing cabinet system 100 is depicted, according to an embodiment. System 100 generally comprises a first user device 102, a second user device 104, and a visual filing cabinet 106.

Embodiments of system 100 can be performed in cloud computing, client-server, or other networked environment, or any combination thereof. The components of system 100 can be located in a singular “cloud” or network, or spread among many clouds or networks. End-user knowledge of the physical location and configuration of components of system 100 is not required.

As will be described, system 100 and/or its components or subsystems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

In embodiments, the system or components thereof can comprise or include various modules or engines, each of which is constructed, programmed, configured, or otherwise adapted, to autonomously carry out a function or set of functions. The term “engine” as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

First user device 102 generally comprises a communications engine 108 and a data capture engine 110. In an embodiment, first user device 102 can be a desktop computer having access to specialized software for interfacing with visual filing cabinet 106. For example, first user device 102 can comprise a web browser configured to access visual filing cabinet 106 through a specialized interface. In another embodiment, first user device 102 can be a mobile device such as a smartphone or tablet configured to access visual filing cabinet 106. For example, first user device 102 can comprise specialized software for the mobile device.

Communications engine 108 is configured to transmit and receive information related to system 100. In particular, communications engine 108 can transmit and receive data specific to the application for which visual filing cabinet 106 is configured, such as property management data. In embodiments, communications engine 108 can comprise communications software and transceiver circuitry. Transmitter circuitry can comprise one or more electronic elements configured to transmit and receive data related to system 100. For example, wireless transceiver circuitry can be configured for radio frequency (RF) communications, WIFI communications, BLUETOOTH communications, or near-field communications (NFC). Wired transceiver circuitries can likewise be utilized, such as CAT-5 and CAT-6.

Data capture engine 110 is configured to capture visual, graphical, positional, or other suitable data at first user device 102. For example, data capture engine 110 can comprise a digital camera for taking a picture of physical asset, such as a section of real property. In another example, data capture engine 110 can comprise a geotagging component, such as a GPS receiver. In an embodiment, data capture engine 110 can be optional on first user device 102. In another example, data capture engine 110 can comprise multiple components to capture multiple pieces of data for a single object (such as the GPS coordinates for a captured picture).

Second user device 104 generally comprises a communications engine 112 and a data capture engine 114. Similar to first user device 102, second user device 104 can comprise a desktop computer having access to specialized software, or a mobile device running specialized software for the mobile device. As depicted in FIG. 1, first user device 102 and second user device 104 are operated by different users.

Communications engine 112 is configured to transmit and receive information related to system 100 similar to communications engine 108. Communications engine 112 is configured specific to second user device 104.

Data capture engine 114 is configured to capture visual, graphical, positional, or other suitable data at second user device 104 similar to data capture engine 110. Data capture engine 114 is configured specific to second user device 104.

Visual filing cabinet 106 generally comprises a communications engine 116, a database 118, and a visual interface 120.

Communications engine 116 is configured to transmit and receive information related to system 100. In particular, communications engine 116 is configured to allow access to visual interface 120 by a first user operating first user device 102 and a second user operating second user device 104. In an embodiment, first user device 102, second user device 104, and visual filing cabinet 106 can be operably coupled by a network, including an intranet network or the Internet.

Database 118 is configured to store the transmitted and received information related to system 100. In particular, database 118 comprises a database configured to the generally-tailored data associated with the particular visual filing cabinet application. Database 118 can be a general purpose database management storage system (DBMS) or relational DBMS as implemented by, for example, Oracle, IBM DB2, Microsoft SQL Server, PostgreSQL, MySQL, SQLite, Linux, or Unix solutions, in embodiments.

Visual interface 120 comprises an engine for delivering visual filing cabinet content stored in database 118 over communications engine 116 to first user device 102 and second user device 104. In an embodiment, visual interface 120 can comprise a web browser-based HTML or XML interface. In another embodiment, visual interface 120 can comprise a software application configured to the unique hardware of the respective devices 102 or 104. As will be readily understood by one of skill in the art, portions of the content of visual interface 120 can be delivered by visual filing cabinet 106 to first user device 102 or second user device 104 for display on the respective devices through device-specific software running on the respective devices. In other embodiments, visual interface 120 can be viewed on visual filing cabinet 106 using Internet-capable browser software.

In an embodiment, visual filing cabinet 106 provides a generalized interface for both first user device 102 and second user device 104. In another embodiment, visual filing cabinet 106 provides a specialized visual interface 120 for first user device 102 and a different specialized visual interface 120 for second user device 104. For example, based on a set of predetermined preferences, first user device 102 is given certain access to the data of database 118, and second user device 104 is given different access to the data of database 118. In this way, data can be tailored to particular users not just based on simple read-write-execute controls, but timing-based controls as well. For example, second user device 104 can be restricted from particular data until after first user acts on the data, such as by opening a particular point for contractor bidding (in a property repair context), or assigning a particular point to a contractor (again, in a property repair context).

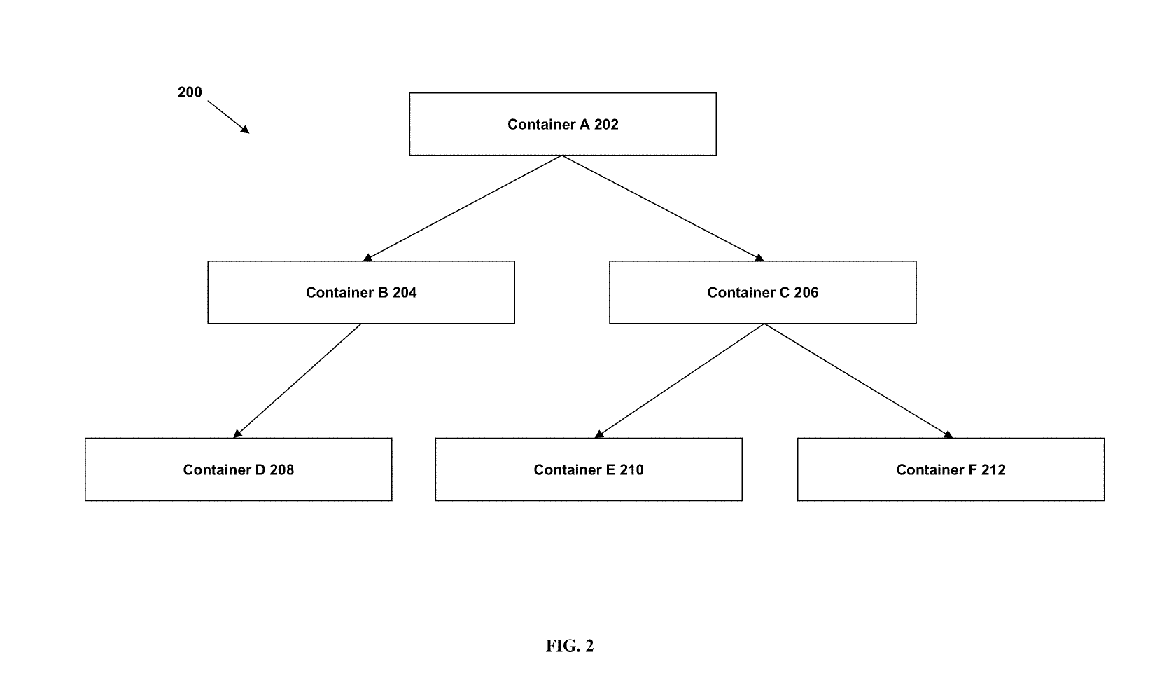

Referring to FIG. 2, a block diagram of a visual filing cabinet data structure 200 is depicted, according to an embodiment. Visual filing cabinet data structure 200 comprises a plurality of containers implemented by hardware and software. For example, the containers described herein with respect to visual filing cabinet data structure 200 can be implemented by database 118 (in combination with a processor and access mechanisms, where appropriate).

In an embodiment, a container comprises a class, a data structure, or data type whose instances are collections of other objects. The containers of visual filing cabinet data structure 200 store objects in an organized way that follows specific access rules.

For example, visual filing cabinet data structure 200 can comprise Container A 202. Container A 202 is a storage mechanism for intermediate containers Container B 204 and Container C 206.

Intermediate Container B 204 is a storage mechanism for lowest-level Container D 208. Intermediate Container C 206 is a storage mechanism for lowest-level Container E 210 and Container F 212.

Each of the levels of containers can comprise not only the layered other containers, but data to be stored at the appropriate level of the container. For example, intermediate-level data can be stored with Container B 204 and Container C 206. Similarly, lowest-level data such as discrete data points can be stored with Container D 208, Container E 210, or Container F 212, as appropriate. These generalized containers can be formed to have any number of levels. In embodiments, the generalization of data storage allows for embodiments of the system to be tailored for any number of real-world applications.

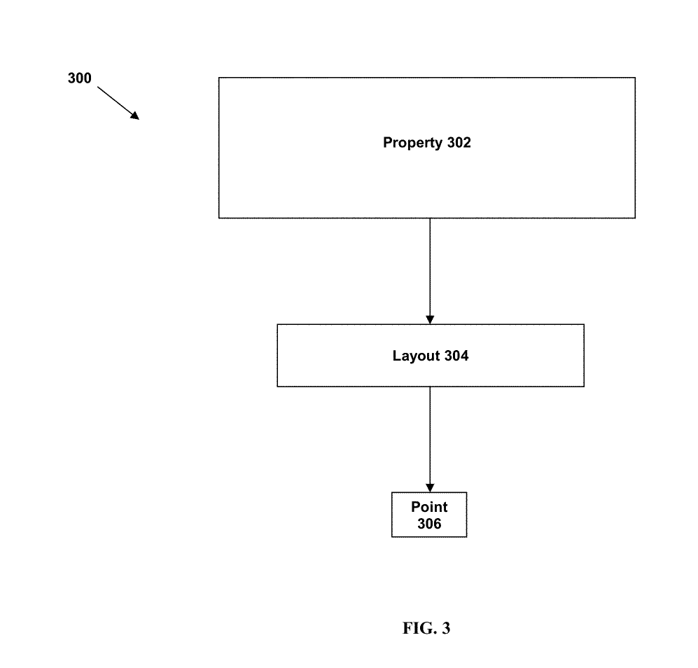

Referring to FIG. 3, a block diagram of a visual filing cabinet data structure 300 for a real property application is depicted, according to an embodiment. In an embodiment, visual filing cabinet data structure 300 comprises objects including a property 302, at least one layout 304, and at least one point 306. In an embodiment, data can be attached to each of property 302, layout 304, or point 306. For example, comments, photos, or PDF documents can be associated, attached, or linked to any of the data structure objects.

Property 302 is a high-level container whose instances are collections of other objects. For example, property 302 can contain or be linked to at least one layout 304. For example, property 302 can comprise a warehouse property container that corresponds to physical real estate that a property manager manages with maintenance from a number of contractors.

Layout 304 is an intermediate-level container whose instances are collections of other objects. For example, layout 304 can contain or be linked to at least one point 306. Continuing the warehouse property example, layout 304 can comprise a map view corresponding to the warehouse property.

Point 306 is a low-level container comprising data specific to a particular point of interest within a particular layout 304 and property 302. In the warehouse property example, point 306 can comprise a point on the map view of layout 304 that needs repair, such as a concrete curb or an exterior light.

In an embodiment, layouts 304 can be static images or dynamic map or satellite images. Layouts 304 allow a user to mark the exact location of any point 306 of interest. Point 306 can be marked either using x-y coordinates for static image layouts 304 or geo-coordinates for dynamic map/satellite layouts 304. Point 306 container can therefore contain the coordinate information, as well as other information, in certain embodiments.

In addition, virtual groupings of points 306 can be created. In the property management context, Jobs, Bid Requests, and Custom List commands can facilitate organizing and storing information specific to portions of the life cycles of points 306. Jobs and Bid Requests can also facilitate interactions between users. Continuing the property management example, and as will be described further below, systems and methods allow Property Managers and Contractors to interact or communicate, while limiting what information is shared between the users.

Visual filing cabinet data structure 300 further allows users to add information to points 306, such as comments, photos and PDF documents. Further, points 306 can be visually organized within embodiments of the system. A history can be created for the tracked point 306. In an embodiment, comments and photos added by a user are added to the Activity Stream of the point 306 along with metadata like user info, timestamps, and geo-locations. In an embodiment, the systems allow for Revisions to break up the Activity Stream of a Point to logical blocks that control the amount of information shared between users, such as Property Managers and their Contractors. A history of point 306 can comprise a collection of the Revisions and the Activity Stream contained within the Revisions.

In an embodiment, property 302 can be associated with multiple layouts 304, which can each be associated with multiple points. For example, property 302 can be associated with a floor plan layout of property 302 and a map view of property 302. Multiple points 306 within each layout 304 can accordingly be associated to property 302. For example, two points of interest can be associated with the floor plan layout, and four points of interest can be associated with the map view layout. In embodiments, multiple layouts 304 can be utilized to reduce the amount of visual clutter on a layout. Further, multiple layouts 304 allow jobs with fixed assets to be readily set up by a user. For example, having both a landscape and HVAC layout allows fast job building for a job related to that layout. Embodiments can further utilize multiple layouts 304 to improve the speed of loading layout loading.

Visual filing cabinet data structure 300 and in particular, the container structure configuration, allows for the flexibility of point tracking and data association. One skilled in the art will readily appreciate that the visual filing cabinet data structure 300 described and depicted in FIGS. 2-3 can be applied not only to collecting and managing facility asset data, but to other industries utilizing data repositories as well.

Visual filing cabinet data structure 300 can be implemented by any number of models, such as a hierarchical database model organized in a tree structure. In such a model, the data is stored as records which are connected to one another through links. A record is a collection of fields, with each field containing only one value. The entity type of a record defines which fields the record contains. In other embodiments, visual filing cabinet data structure 300 can be implemented by a linked list, array, class, or other suitable data structure or combination of the abovementioned data structures.

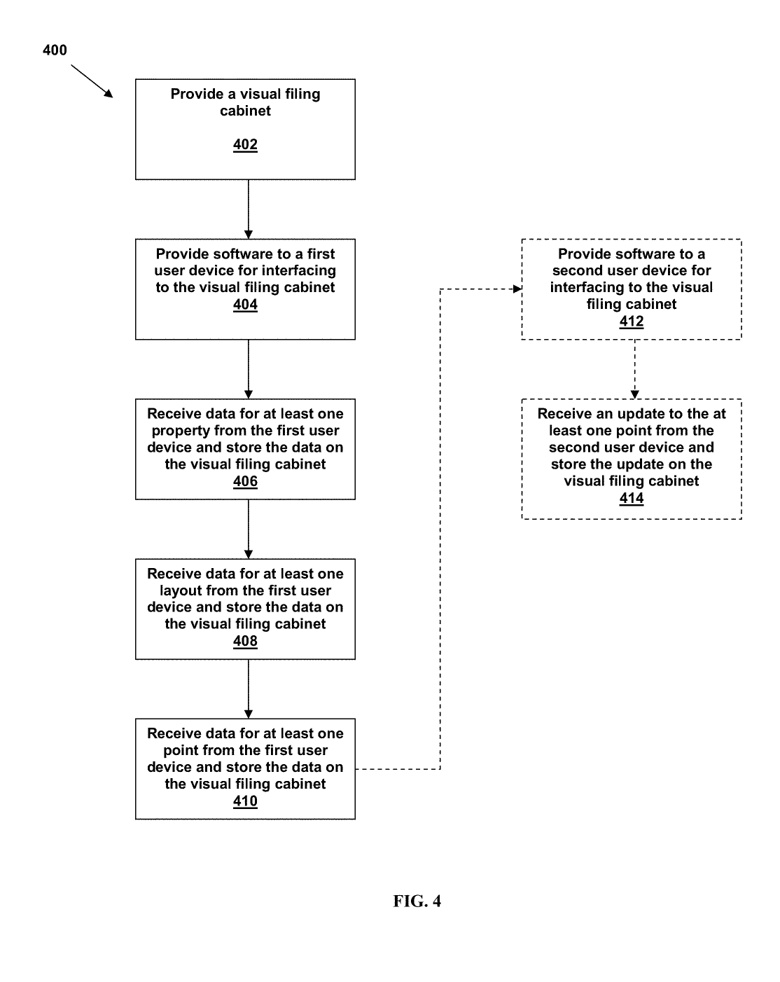

Referring to FIG. 4, a flowchart of a method 400 for managing a visual filing cabinet system, such as the visual filing cabinet system of FIG. 1, is depicted, according to an embodiment. Reference to the components of FIG. 1 will be made for ease of explanation of method 400.

Method 400 generally includes providing a visual filing cabinet 402. In an embodiment, method 400 provides visual filing cabinet 106. Visual filing cabinet 106 is made available by general operational configuration and by operably coupling visual filing cabinet 106 to a network.

Method 400 further includes providing software to a first user device for interfacing to the visual filing cabinet 404. In an embodiment, the first user device is first user device 102 of system 100. At 404, method 400 can therefore provide all or a portion of communications engine 108 for communication with visual filing cabinet 106.

Method 400 further includes receiving data for at least one property from the first user device and storing the property data on the visual filing cabinet 406. In an embodiment, first user device 102 can utilize its communications engine 108 to interface with communications engine 116 of visual filing cabinet 106 to transmit data related to the at least one property. For example, the data for the at least one property can comprise a property name, location, type, or other characteristics. A property manager user operating first user device 102 can enter, select, or otherwise input the property data into first user device 102. For example, the property manager user can utilize data capture engine 110 to take a picture of the property. In embodiments, the picture can be analyzed or parsed to determine the data for the at least one property. In embodiments, the data for at least one property is stored by visual filing cabinet 106 in database 118.

Method 400 further includes receiving data for at least one layout from the first user device and storing the layout data on the visual filing cabinet 408. In an embodiment, first user device 102 can utilize its communications engine 108 to interface with communications engine 116 of visual filing cabinet 106 to transmit data related to the at least one layout. For example, the data for the at least one layout can comprise a floor plan layout for the property transmitted in 406. The property manager user operating first user device 102 can enter, select, or otherwise input the layout data into first user device 102. For example, the property manager user can utilize data capture engine 110 to take a picture of the layout. In embodiments, the picture can be analyzed or parsed to determine the data for the at least one layout. In embodiments, the data for at least one layout is stored by visual filing cabinet 106 in database 118.

Method 400 further includes receiving data for at least one point from the first user device and storing the point data on the visual filing cabinet 410. In an embodiment, first user device 102 can utilize its communications engine 108 to interface with communications engine 116 of visual filing cabinet 106 to transmit data related to the at least one point. For example, the data for the at least one layout can comprise a repair point on the layout transmitted in 408 for the property transmitted in 406. The property manager user operating first user device 102 can enter, select, or otherwise input the point data into first user device 102. For example, the property manager user can utilize data capture engine 110 to take a picture of the point. In embodiments, the picture can be analyzed or parsed to determine the data for the at least one point. For example, repair item data can be generated from the picture. In another example, the picture of the point is geotagged to provide additional information related to the point. For example, embodiments can verify the geotagged picture applies to the point for which the picture provides documentation (at the location of the point). In embodiments, the data for at least one point is stored by visual filing cabinet 106 in database 118.

The property, layout, and point data referred to in 406, 408, and 410 can be stored according to visual filing cabinet data structure 300 as depicted in FIG. 3. As will also be readily understood by one skilled in the art, the property, layout, and point data do not need to be transmitted or input serially, but can be transmitted in a packet as appropriate for the network and user device.

In an embodiment, method 400 optionally further includes providing software to a second user device for interfacing to the visual filing cabinet 412. In an embodiment, the second user device is second user device 104 of system 100. At 412, method 400 can therefore provide all or a portion of communications engine 112 for communication with visual filing cabinet 106.

Optionally, method 400 further includes receiving an update to the at least one point from the second user device and storing the updated data on the visual filing cabinet 414. In an embodiment, second user device 104 can utilize its communications engine 112 to interface with communications engine 116 of visual filing cabinet 106 to transmit data related to the at least one point. For example, a contractor user can “respond,” using second user device 104, to a request for proposal for the repair item specified by the at least one point. In another example, the contractor user user, having repaired the repair item, can utilize data capture engine 114 to take a picture of the point. In embodiments, the picture can be analyzed or parsed to determine the data for the at least one point.

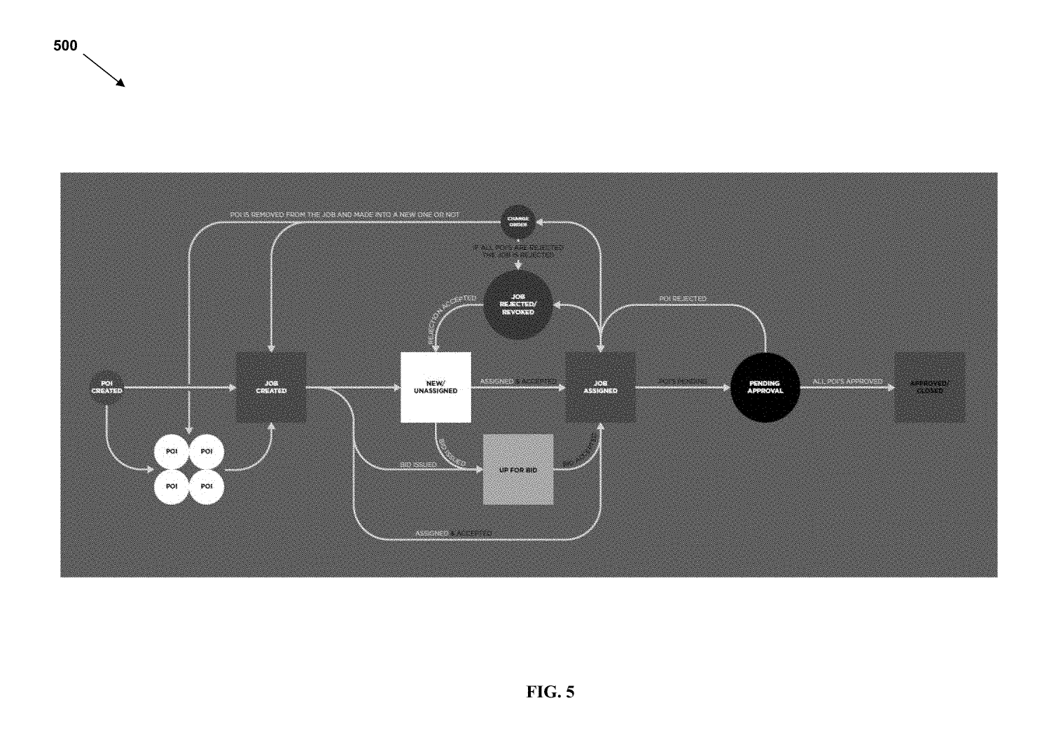

Referring to FIG. 5, a flowchart of a method 500 for visually managing property management data is depicted, according to an embodiment.

In an embodiment, jobs and bid requests can be used to group points together temporarily. In embodiments, jobs and bid requests can be used to communicate point-specific information between property managers and contractors. For example, contractors can be internal or external resources. Contractors facilitate different business processes and can therefore have different organizational structures.

Bid requests allow multiple contractors to bid on the same project scope. For example, bid requests can comprise a data structure having multiple branches. The multiple branches of a bid request allow a first contractor to input different information into his particular bid than a second contractor. Multiple branches further allow the property manager to interact with each bidding contractor separately. In an embodiment, if a winning bid is selected and turned into a job for the winning contractor, the other branches of the same bid request are closed and the submitted information contained in the different branches is stored as historical data.

Jobs, on the other hand, can comprise a data structure having a single branch. The single branch allows the property manager and one contractor to define the scope of a project and to track the progress of the project as it moves through the job workflow. Due to different use cases, both the property manager and the contractor can create jobs and define the scope of the job by selecting existing points or adding new points. However, this can be restricted as needed by embodiments of the system. In an embodiment, only a property manager can create a new job but the scope of an existing job can be modified by either the property manager or the contractor. In another embodiment, the contractor can create a new job (as well as modify an existing job).

Embodiments of the system are configured to mark or denote the location of various points on layouts. Further, embodiments are configured to allow users to “attach” information specific to each location, thereby creating the visual embodiments of the tool. Points can be used to track assets over time (like a commercial HVAC unit on top of a commercial building) or one time tasks using “throw away” or temporary points (like a crack on the sidewalk that needs to be repaired).

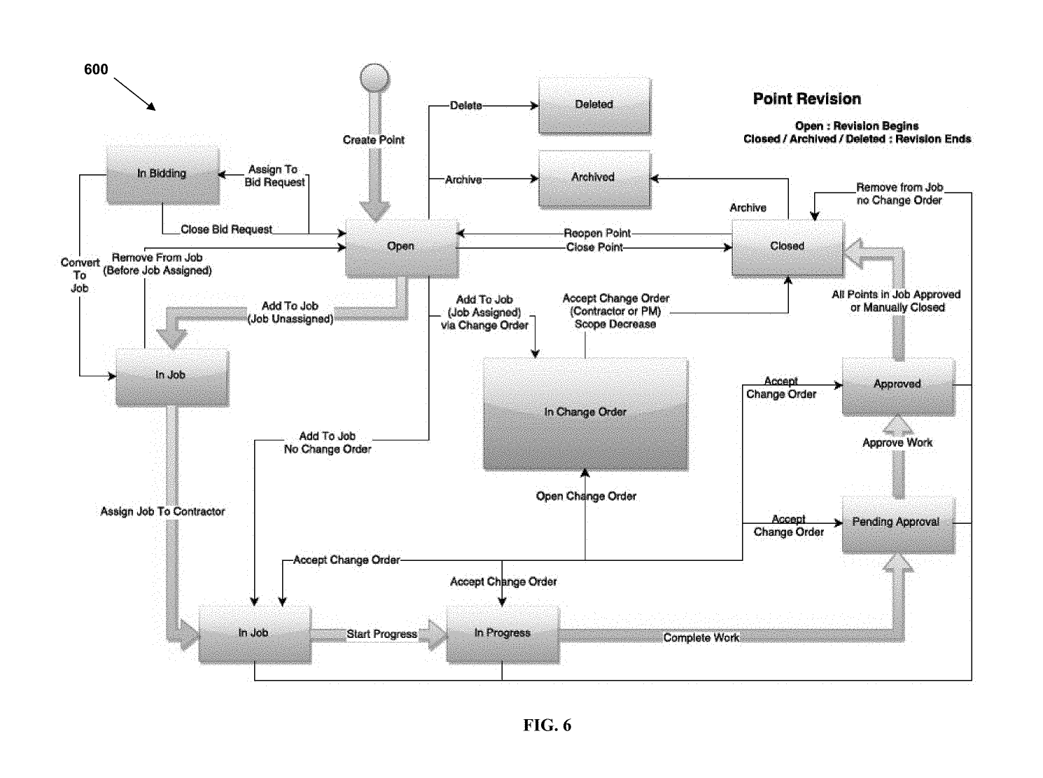

Referring to FIG. 6, a flowchart of another method 600 for visually managing property management data with points is depicted, according to an embodiment.

When a point is created, its status is set to open. The point can then be used to collect point-specific information in the form of text comments, images, or documents such as PDFs or Word documents. If work needs to be done on the point, such as a repair, the point can be either placed into a bid request or a job depending on the specific need.

If one or multiple bids are required, the point is put into a bid request status (status Open->In Bidding). At this stage, the point can either be removed from the bid request (status In Bidding->Open), moved into a job by converting the bid request into a job (status In Bidding->In Job), or the user can close the bid request without converting it into a Job (status In Bidding->Open).

When a point is placed in a job, either by directly being assigned to a job (status Open->In Job), or by being part of a bid request that was rolled into a job (status In Bidding->In Job), the point can transition between several job-related states. If the job is an unassigned job, the point can be removed from the job (status In Job->Open).

If the job is assigned to a contractor, the point can follow several different paths, according to embodiments. A direct path begins with work being started on the point (status In Job->In Progress). When work is completed on a point, it is marked as ready for approval (status In Progress->Pending Approval). When the work is accepted by the property manager, the point is marked approved (status Pending Approval->Approved). Finally, the point status-cycle ends when a point is moved into closed state.

In another path according to embodiments, the point can be removed from the job with a change order (status In Job/In Progress/Pending Approval/Approved->In Change Order->Closed), or without a change order (status In Job/In Progress/Pending Approval/Approved->Closed).

Further, the point can also be put into a change order by either the property manager or the contractor. In embodiments, placing the point into a change order status can indicate to the other side important scope change other than point removal (status In Job/In Progress/Pending Approval/Approved->In Change Order). Acceptance of this type of change order returns the point to the same status as prior to the change order (status In Change Order->In Job/In Progress/Pending Approval/Approved).

Additional existing points or new points can be also added to an already assigned job by the property manager with a change order (status Open->In Change Order->In Job) or without a change order (status Open->In Job). For example, in an embodiment, a contractor can also add new points to an already assigned job with or without change order, but cannot add existing points.

In an embodiment, points can be archived in both an open or closed state. (status Open/Closed->Archived). According to embodiments, archived points are hidden on the layouts by default, but can be displayed by filtering for them. If needed, archived points can be restored to active status (status Archived->Open/Closed).

As shown below, information can be posted in the “activity stream” of a point. In an embodiment, a single “revision” in the history of a point can include the information posted in the activity stream beginning with a point status of “open” and ending with a point status of “closed.” In other words, any time a point is part of a new job, a new revision is created and all new information recorded in the activity stream of the point are stored in the new revision. For points that represent permanent assets, those points are likely to include several revisions in the point history over the life of the asset. Thus, revisions can control the amount of information shared between property managers and the contractors assigned to different jobs.

Referring to FIG. 7, an example work flow between users of the system is depicted, according to an embodiment. For example, each role can assign certain privileges within the system. In an embodiment, the manager role has all the features of a property manager but by default gets none of the notifications. The manager role further comprises the ability to change the responsible property manager for a job created by any role. In an embodiment, the property manager role by default receives point and job notifications and has approval authority. In an embodiment, the contractor role can add other resources (internal or external) to the job. Further, when a foreman role is assigned, the contractor role gets no notifications by default. In an embodiment, the foreman role can add other resources (internal or external) to the job. Further in embodiments, the foreman has the same capabilities in the system as the property manager. In an embodiment, the worker role can add properties, layouts, jobs and points. The worker role can have restrictions such only being able to assign jobs to themselves or to certain crews. (Their list of possible assignees is restricted). According to embodiments, all of the described roles can be predefined or established ad-hoc. Further, as shown in the work flow of FIG. 7, the roles can cascade down based on permissions.

Property Manager Teams

For example, in a particular use case of property manager teams, wherein the manager spots an issue on her property and assigns the issue to a property manager who works for her. For example, referring to FIG. 7, the manager can assign the work to PM3 (a user having a property manager role). The property manager then assigns the work to Contractor1 (a user having a contractor role). The contractor then assigns the work to Worker3 (a user having a worker role). In an embodiment, all of the users see all of the assignments and are notified as the work is assigned.

In an embodiment, the issue can be spotted and assigned as follows. The manager creates a point and assigns project responsibility to PM3. After assigning, the manager no longer receives notifications or approvals for the job. PM3 can then assign job responsibility to Contractor1. Contractor 1 receives all notifications for the points associated with the job, as well as all job notifications. Contractor1 then assigns work to Worker3. Worker3 then completes the work. Worker3 or Contractor1 can then change the status of the points for which work was completed.

In an embodiment, Worker3 can create a change order. Notifications go to Contractor1 and PM3 (their respective user devices). PM3 can then approve change order through the user device.

In another embodiment, PM3 can request a change order. Notification goes to Contractor 1 AND Worker3 (their respective user devices).

Sub-Contractor Managing Upstream Notifications

For example, embodiments allow a particular use case where a sub-contractor wishes to restrict the activity seen by the property manager. Consider again an example where the manager spots an issue on her property and assigns the issue to a property manager who works for her. The property manager assigns the work to a contractor, who assigns it to a sub-contractor (using the role of a manager).

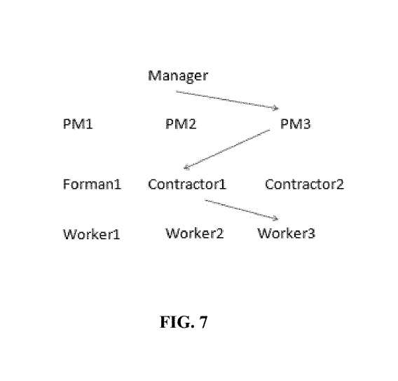

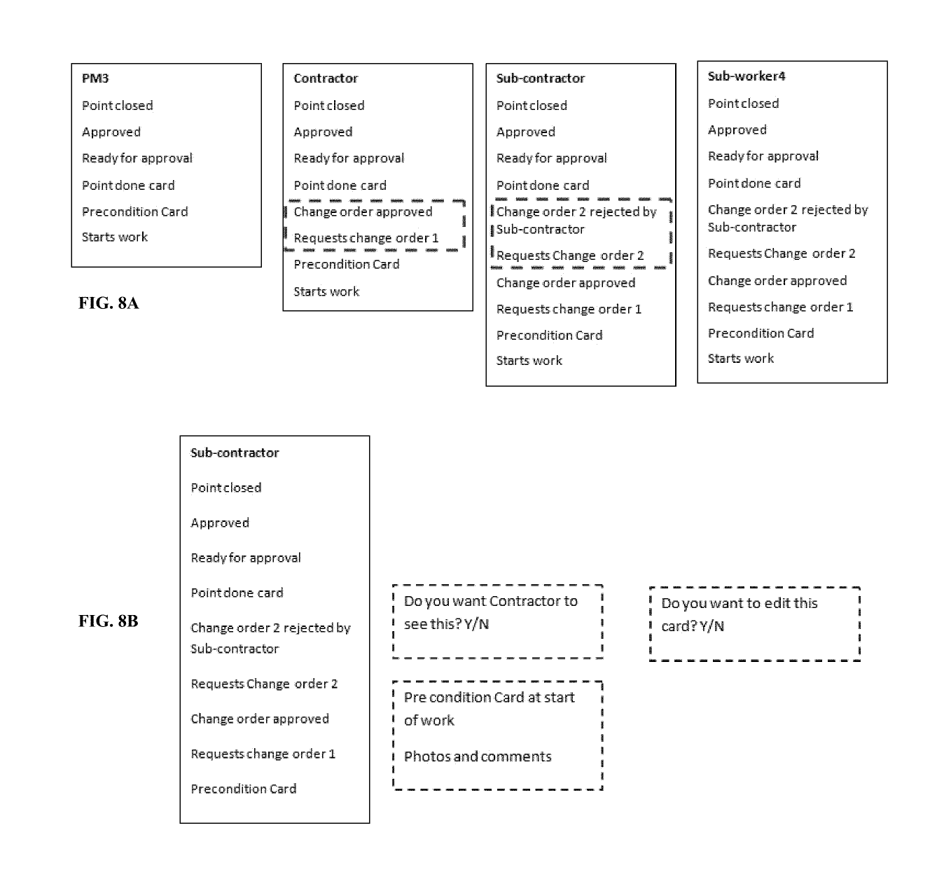

In an embodiment, the issue can be spotted and assigned as follows. The manager creates a point and assigns project responsibility to PM3. After assigning, the manager no longer receives notifications or approvals for the job. PM3 can then assign job responsibility to Contractor1. Contractor 1 receives all notifications for the points associated with the job, as well as all job notifications. Contractor1 then assigns work to a sub-contractor (referring to FIG. 8A, Sub-worker 4). In embodiments, Contractor1 decides what PM3 can see on his user device.

In an example, Sub-Worker4 requests a change order. Notification goes to sub-contractor and sub-contractor allows Contractor1 to see the change order. In an embodiment, Contractor1 does not allow PM3 to see the change order request. Contractor1 approves the change order from sub-contractor.

In another example, Sub-Worker4 requests another change order. Embodiments allow Sub-contractor to override Sub-Worker4 and deletes the request.

In another example, the Sub-worker associated with Sub-Worker4 completes the work and updates the point status to closed. The Sub-contractor is notified, agrees, and allows PM3 to see the status change.

In an embodiment, Sub-subcontractor users can approve “cards” or individual photos and comments to be seen by users upstream, such as the contractor. The contractor can approve the “cards” or individual photos and comments to be seen by property manager. For example, referring to FIG. 8A, at the end of the job described above, the point status for the various users of the system is depicted. Note the content in dashed boxes is not passed upstream.

Referring to FIG. 8B, a diagram of a job point including prompts to a sub-contractor for passing information is depicted, according to an embodiment. For each card in the point, the Sub-Contractor answers “yes” before the information is passed on (presented) to the contractor (and to other upstream users).

According to embodiments, several types of jobs can be implemented between components of the system, such as first user device 102, second user device 104, and visual filing cabinet 106 as depicted in FIG. 1. These jobs can take predefined paths through the algorithmic logic as use cases of system 100. As such, jobs can comprise default settings, displays, or permissions.

According to embodiments, jobs can have assigned points, wherein points are used to help service people identify the equipment to be serviced. For example, filters for particular air exchangers need to be changed on a schedule. A job can define a filter change.

In another embodiment, jobs can comprise points added through a change order process. For example, if the property manager requires a snow pile to be moved because of an internal change and not because it was put on the wrong location according to the job request, the new snow pile location point can be added through a change order.

Job Type: Service Verification without Notifications

For example, service verification without notifications can be implemented. In an embodiment, jobs are open-ended. In particular, jobs are expected, so job data structures are available to be instantiated by embodiments of the system, but because the jobs are unscheduled, the specific data structures are not instantiated and undefined at initial run-time. In another embodiment, the scope of jobs can be known, and therefore closed-ended. In particular, when the scope of a job is known (such as by filter changes or when a general schedule is known), the type of work is known ahead of time. Therefore, job data structures and associated data structures can be instantiated at run time or otherwise presented to the user when the user accesses the visual filing cabinet. In an embodiment, points are used for verification. Points can be added by workers operating a user device. Examples of service verification jobs without notifications include snow removal, lawn care (such as fertilizing), janitorial jobs, handyman jobs, and HVAC maintenance.

According to embodiments, a worker using a user device can create be assigned an empty job and add one or more points to the job. The worker can operate the user device while doing the work. The worker can further utilize the user device to assign the job to himself. In such embodiments, it is the contractor's responsibility to know when to initially send the worker to the job site (no notifications are generated by the system). In other embodiments, points can be placed into a watch list. In still further embodiments, the worker operating the user device can create a future job that can be put in a list.

Job Type: Service Verification with Notifications

In another example, service verification with notifications can be implemented. In an embodiment, a one-time job including the proposed time and material are known by users of the system. Jobs can be therefore defined in real time. For example, a job can be created by a user of the system and the job scope can be preapproved by two users either as part of the system or outside the system. According to an embodiment, points can be used for verification and communication about the job. Similar to the service verification example without notifications, if a worker sees an issue while on a job site, the worker can operate the user device and assign the job to himself. Examples of service verification jobs with notifications include work found during routine inspection such as an overflowing drain, or where trusted contractor by the property manager is on-site. In embodiments, because the work may be invoiced separately from the inspection, the property manager may want notifications to his user device. According to embodiments, a worker using a user device can create a job and assign the job to himself. Notifications such as job assigned, change order, or pending approval, are routed to the property manager user device and/or the contractor manager user device.

Job Type: Contractor's Assessment

In another example, a contractor's assessment can be implemented. For example, if a contractor wants to win new work, or if the property manager wants to know the condition of his property, the contractor's assessment use case can be executed. According to an embodiment, jobs are open ended. In particular, jobs are expected, so job data structures are available to be instantiated by embodiments of the system, but because the jobs are unscheduled, the specific data structures are not instantiated and undefined at initial run-time. In such embodiments, a contractor can walk the property at an unscheduled time, access the system to define and document the specifics of the scope of work. In embodiments, the type of work (but not the particular scope of work) can be known ahead of time. Therefore, the system can be open-ended to accept data for any type of work or tailored types of work. Points can be used for presentations. In an embodiment, points can be added by workers operating a user device. If contractor does not have a relationship with the property manager, the worker can add a new property and layout on the contractor's data. Examples of contractor's assessment jobs include lawn care, hardscape, landscape, or concrete work. According to embodiments, a worker using a user device can create a job and assign the job to himself. The worker, using one or more user devices, can add property or layout data on the system, depending on the parameters guided by the system.

Job Type: One-Time Job

In another example, a one-time job of known scope can be implemented. In an embodiment, the scope of the one-time job is known, and therefore closed-ended. In particular, when the scope of a job is known the type of work is known ahead of time. Therefore, job data structures and associated data structures can be instantiated at run time or otherwise presented to the user when the user accesses the visual filing cabinet. In an embodiment, points are used for work instruction and documentation of the one-time job. Examples of one-time jobs include repair or replacement jobs, concrete, roofing, plumbing, painting, or information technology (IT) installs or repairs.

According to an embodiment of a one-time job of known scope, a property manager can create one or more jobs from existing points. The property manager can then assign the job to a contractor. The contractor then physically completes the work related to the job and moves the point through the update process. For example, the job may have gone through a bidding process among contractors. Thus, the job can be moved from “bidding” to “assigned” to “closed” statuses.

According to another embodiment of a one-time job of known scope, the property manager creates a job having one point. In an embodiment, the job is for the contractor to figure out what needs to be done. The worker, using one or more user devices, can create additional points for the job. In this example, points that the property manager does not want addressed are closed or deleted with no work in them. Embodiments of this process can be utilized instead of the bid process.

Job Type: Multiple Jobs on One Asset

In another example, multiple jobs on a single asset can be implemented. For example, points can be reused from different pre-existing jobs. In further embodiments, points having information to be reused can reside in different revisions. Points can be “working points” such as “A/C unit” or contain information about the asset, such as “use gray paint.” Examples of multiple jobs on a single asset include mechanical, HVAC, bowling alley repair, IT, paint color, plumbing, or junction box locations.

According to an embodiment, after a point is created, information to be referenced (comments, photos) is “starred” as important, which means it will be presented in the summary section of the point. The point is then put into a list (e.g. “HVAC unit info”). To add this information to a job, the property manager can add points from the list to the job. The name of the point can be labeled for reference (e.g. “Condenser information,” or “HVAC circuit NW”). Documents with information can also be added to the point by the property manager or the contractor. As such, embodiments allow access to specific photos on the user device by the property manager or the contractor.

In another embodiment, all previous history of a point is presented to the contractor on a job-by-job basis. Thus, when a new job is created, the property manager allows the contractor to see all history of each point that are in that particular job. This effectively provides the necessary information to the contractor but only when the property manager desires that the contractor be able to access this information.

Future Jobs Defined by a General Contractor

In another example, future jobs defined by a general contractor can be implemented. In this use case, the visibility of some information is limited according to particular users. For example, consider a general contractor for a large building having an owner, a main tenant, wherein the general contractor uses sub-contractors.

The general contractor can operate a user device to set up the property. In another embodiment, the general contractor can set up one or more layouts. Sub-contractors can create jobs and add points. If a sub-contractor finds an issue believed to be a change order, the sub-contractor creates a job and a change order.

Further, consider the main tenant finding an issue to raise with the general contractor. The tenant can operate a user device to create a point and ask the question within the system. In embodiments, when various users (such as the main tenant) generate a point in the system, the general contractor (and other users, where applicable) can be notified.

The general contractor can further determine which sub-contractors (if any) can see points, layouts, and properties set up by the general contractor.

Reports can further be generated to aid the general contractor. For example, consider users without access to the system, or without access to the job. A report can be generated having information regarding the job or point at issue, including the layout and property, comments, photos, and other text. In embodiments, a link can be provided to only access the information the general contractor has selected for that report.

In particular, an embodiment includes a manager operating a user device to select point information to be shared. The manager can then click or otherwise select a display device to “share information,” such as a display button. The point activity stream is then displayed. In an embodiment, only one point revision is displayed. In an embodiment, the manager can then select information to be shared. The manager can select information including all data, by card, or by particular information in the card.

Access can then be sent to a receiver user (for example, an off-line user or a user without access to the point or job). In an embodiment, the receiver can view the point layout with only the manager-selected point(s) displayed. In another embodiment, the receiver can view the point activity stream with only the manager-selected information displayed. For example, the manager-selected information can be displayed via internet link. In embodiments, the information is displayed in PDF format. In other embodiments, the receiver user is provided very limited access to the system. Receiver users can add data to the system, such as comments. In an embodiment, this data is stored in a separate container such that the data does not go into the activity stream. The receiver user data is stored in a container accessed through the summary screen. However, a note can be added to the summary section of the activity stream indicating there are “offline” conversations or other data. In embodiments, the container can be generated with the information presented in the conversation. The container is attached at the job or point level and is retrieved in the summary section respectively of points or jobs In another embodiment, a PDF format report can be generated by selectively outputting information into an electronic document format.

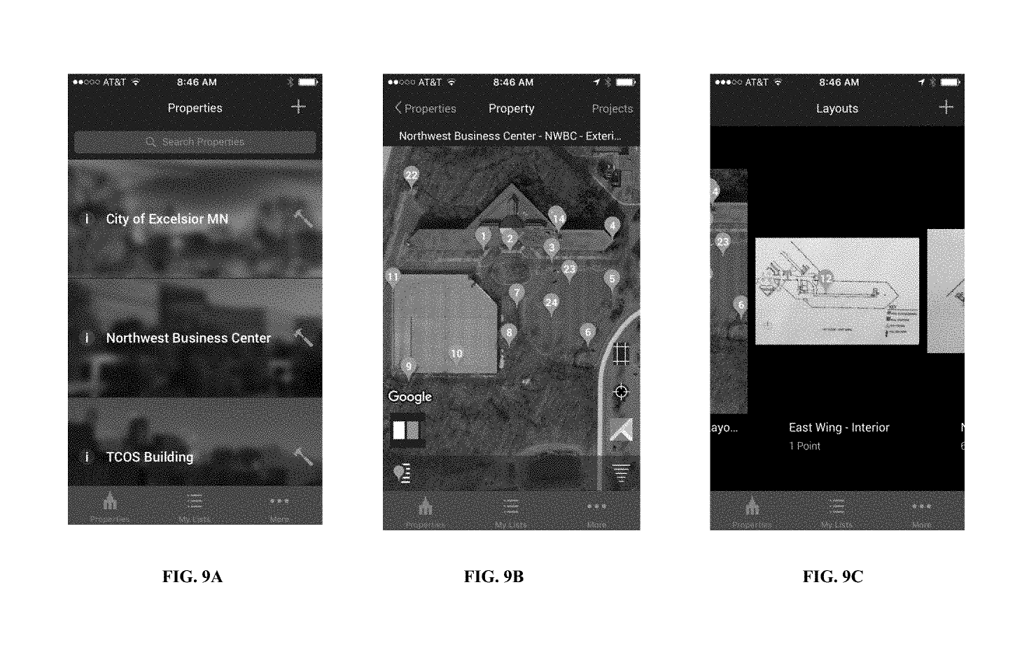

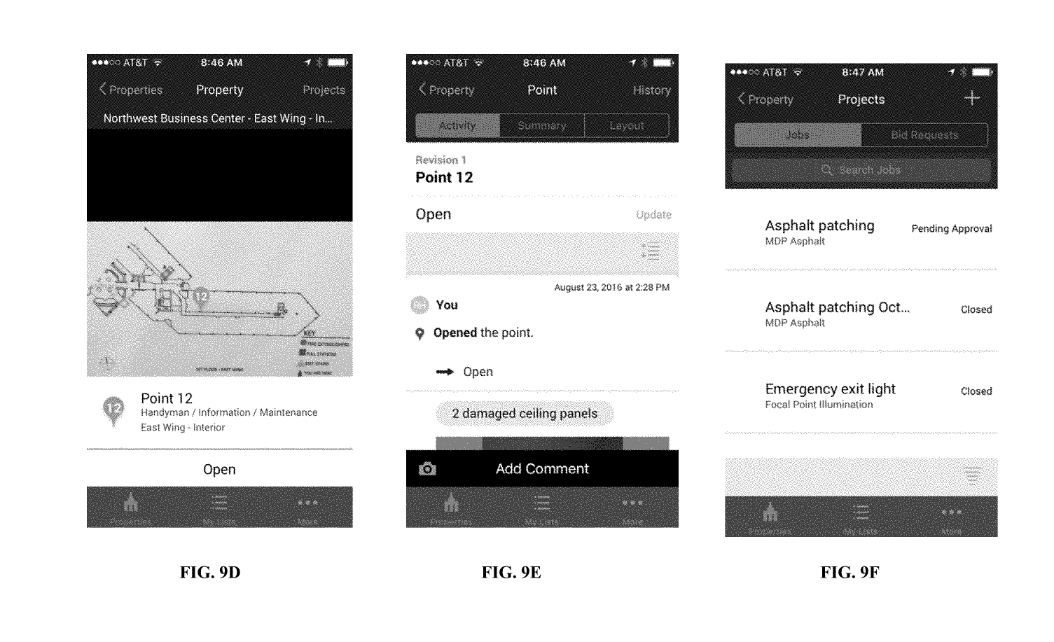

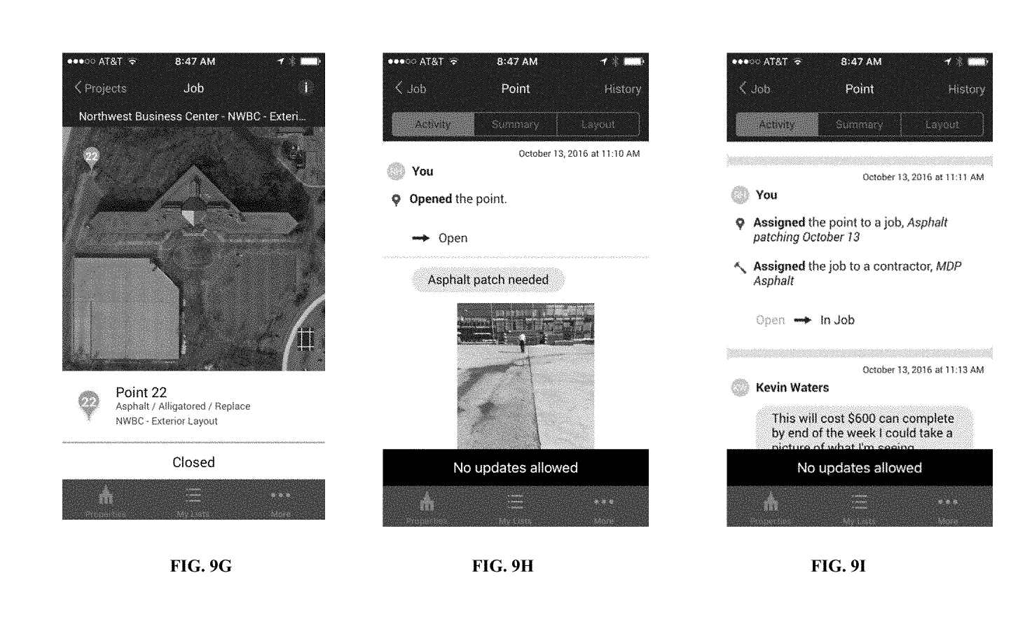

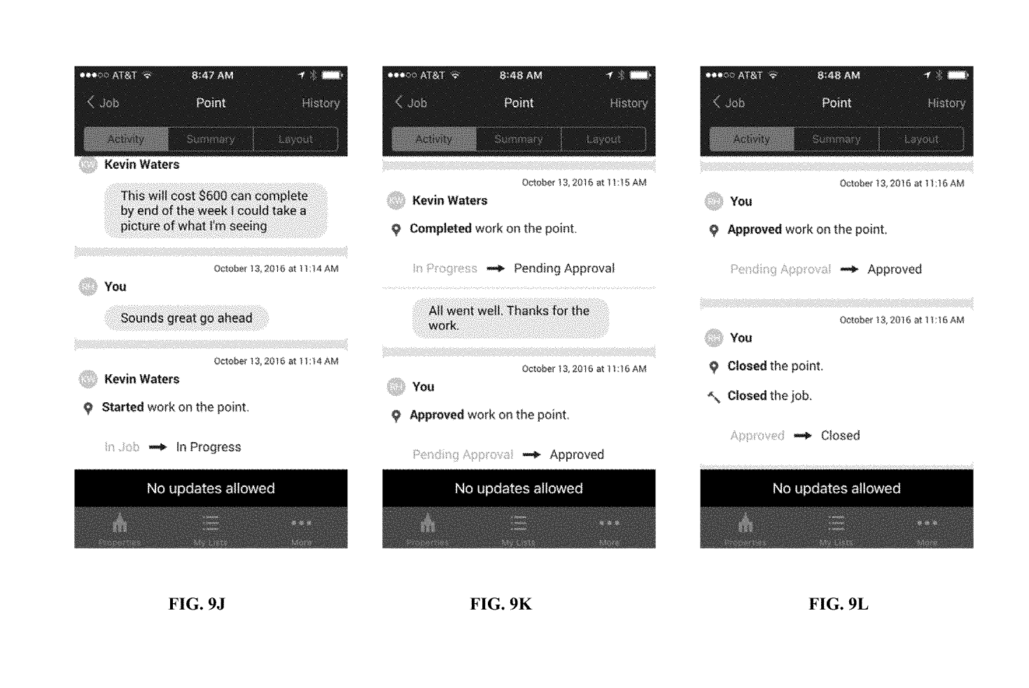

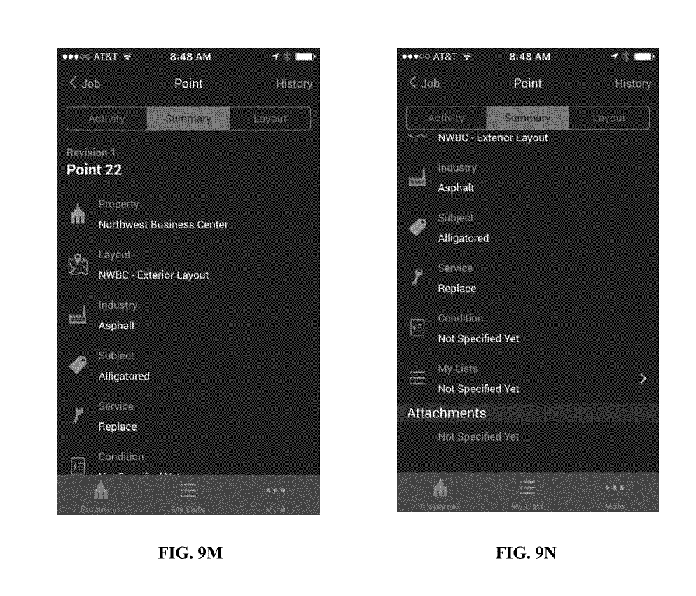

Referring to FIGS. 9A-9N, screenshots of a visual filing cabinet system are depicted. In particular, the screenshots depict the workflow of a property manager checking on a job status, according to an embodiment. For example, referring to FIG. 1 and system 100, the screens shown can be presented by visual interface 120 or data from database 118 on first user device 102 or second user device 104. In embodiments, selective information is displayed for mobile native apps due to generally small screen size of mobile devices relative to large screen availability in web (desktop-based applications).

In FIG. 9A, a home screen is depicted. As shown, multiple properties can be displayed on the home screen. In FIG. 9B, an exterior layout having multiple points is depicted. In FIG. 9C, an interior layout is depicted. In embodiment, as depicted, the property “Northwest Business Center” has multiple layouts. In FIG. 9D, a point info preview or “peek-a-book” view is depicted. The point info preview can be shown after the user taps or clicks the point he wishes to preview. In FIG. 9E, an open point thread is depicted. The open point thread contains an activity stream for the point. In FIG. 9F, a job list is depicted. The job list can be selected by the “Jobs” tab within the “Projects” tab from the home screen. In FIG. 9G, a job layout with a point is depicted. In FIGS. 9H-9L, a point activity stream within a job thread is depicted. In FIGS. 9M-9N, a point summary tab is depicted.

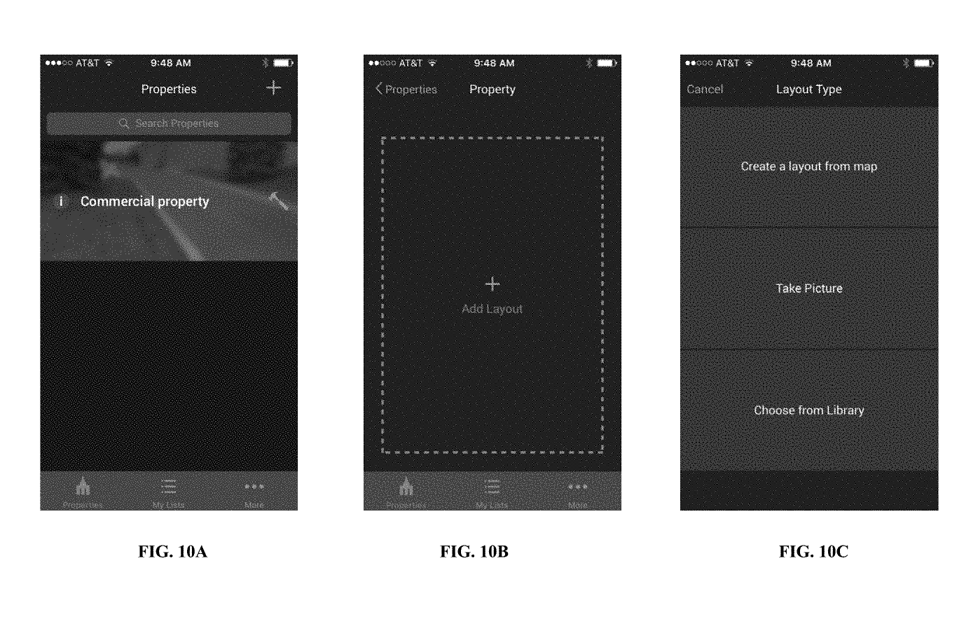

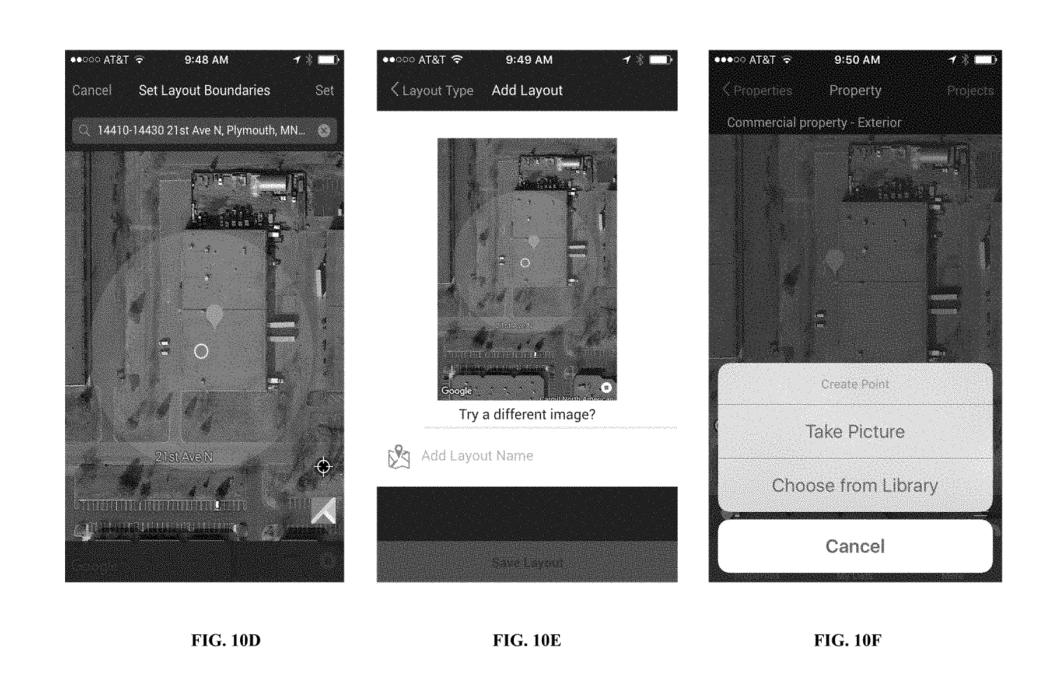

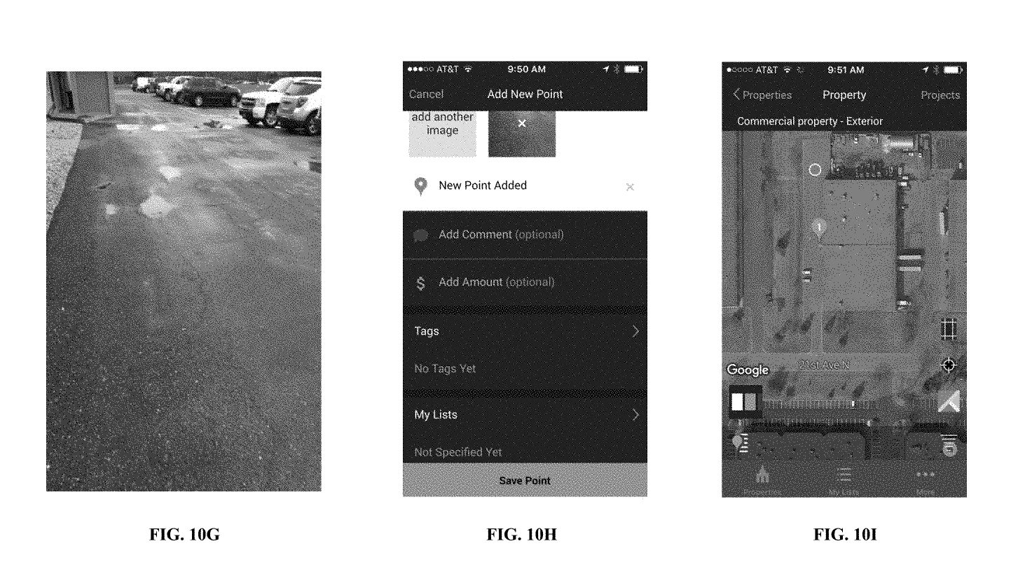

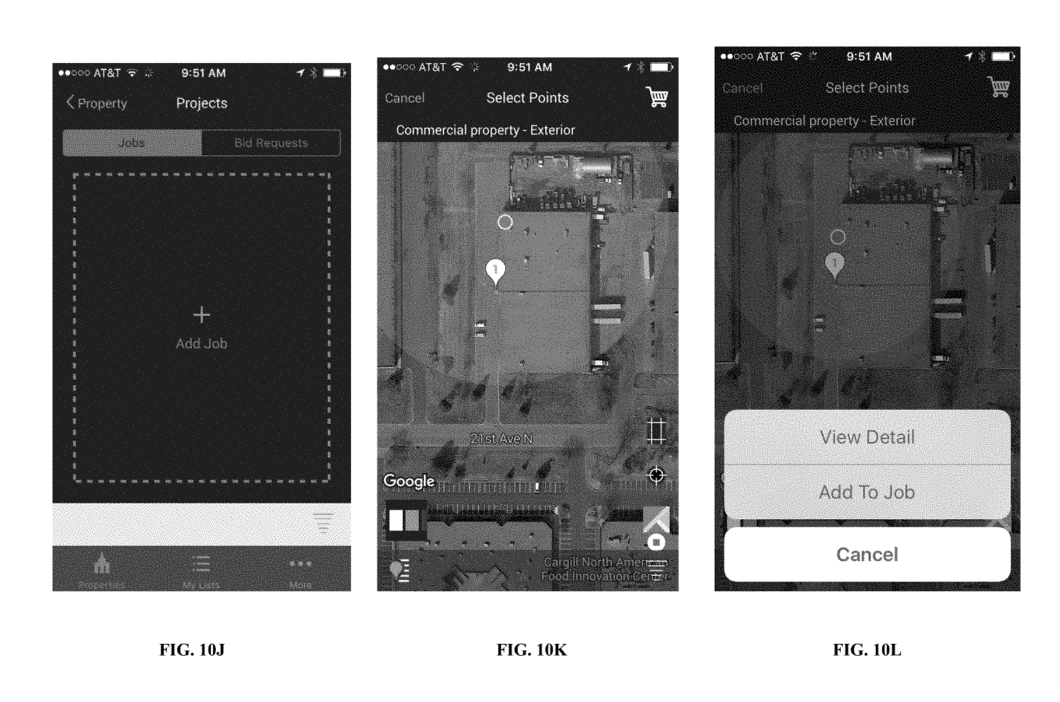

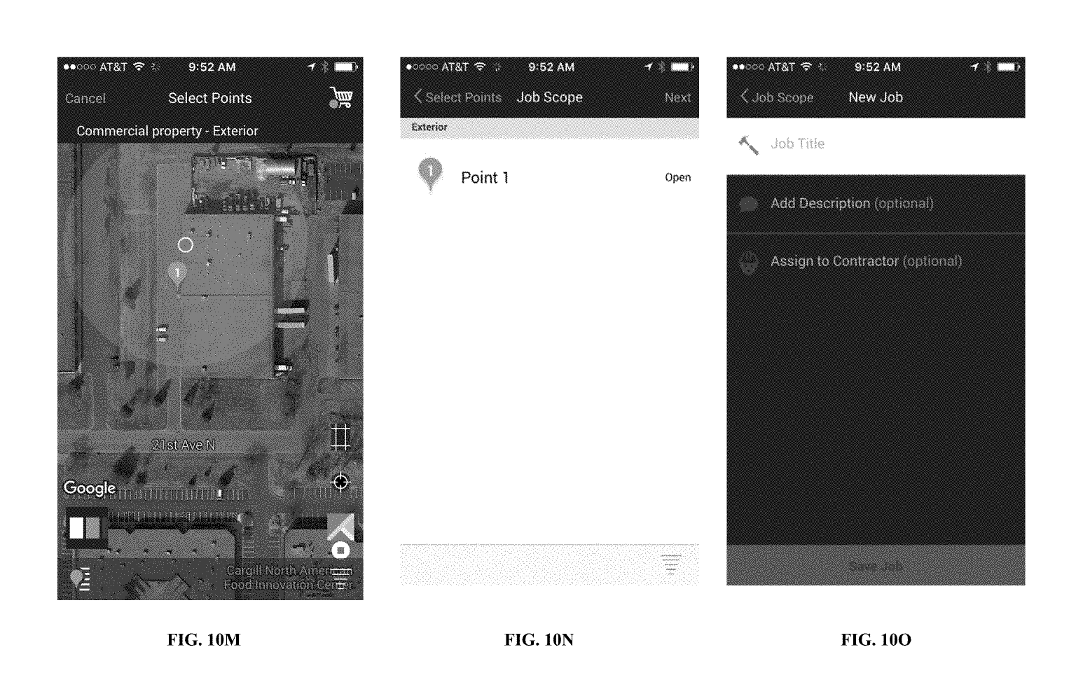

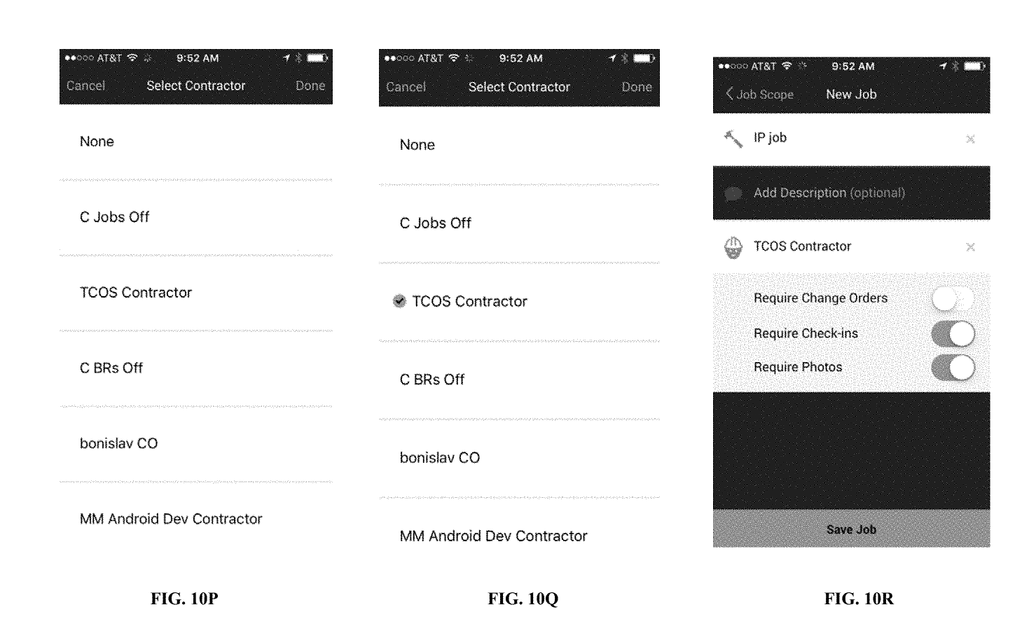

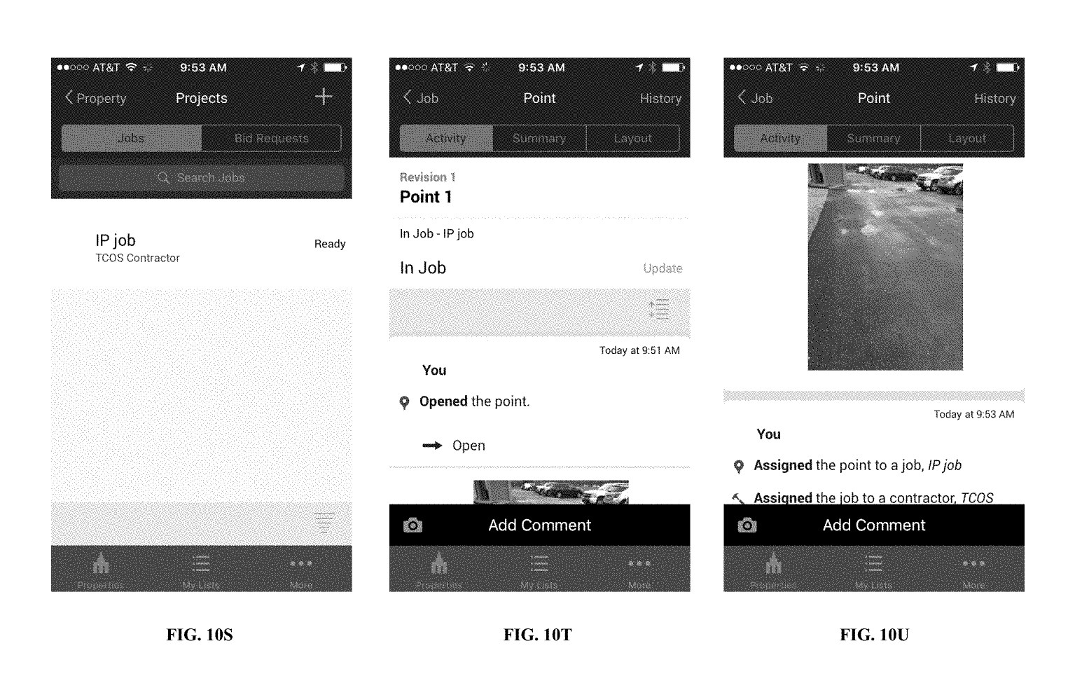

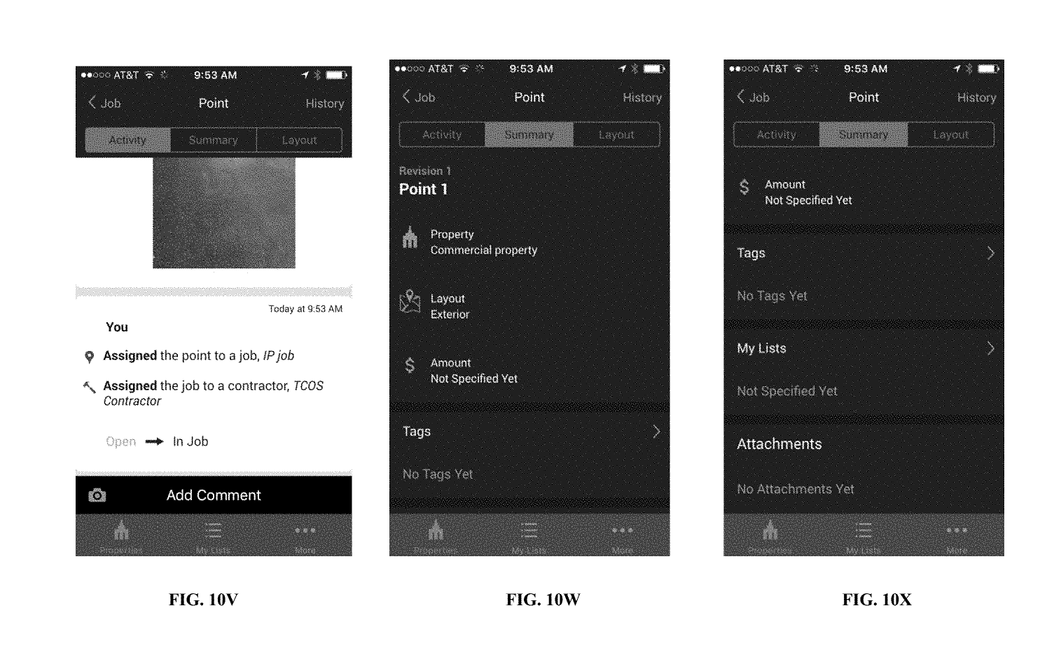

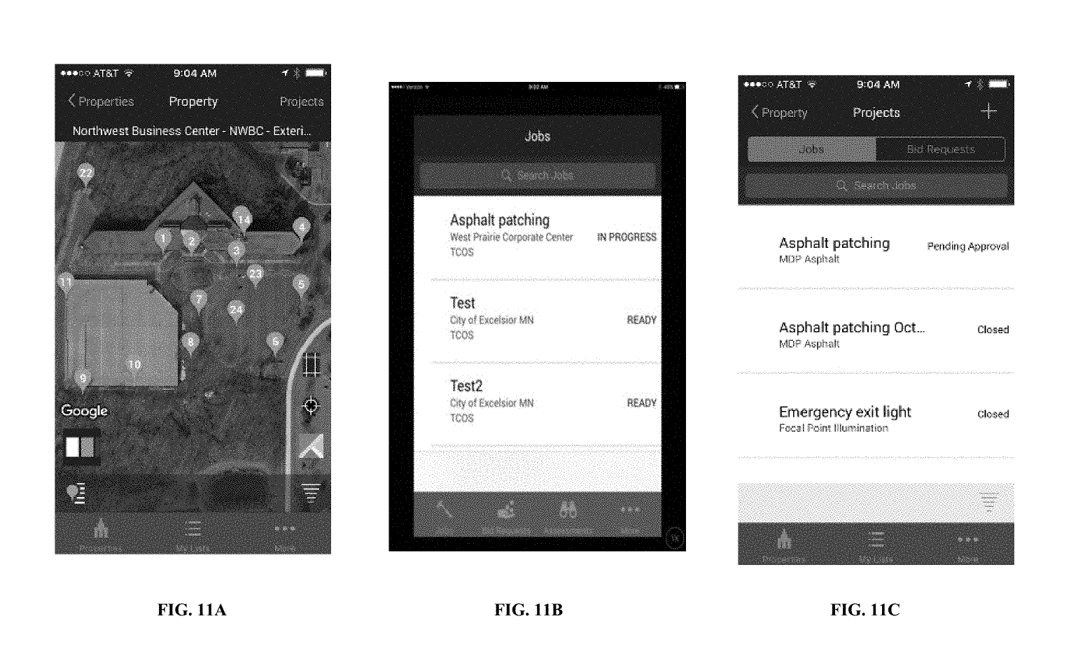

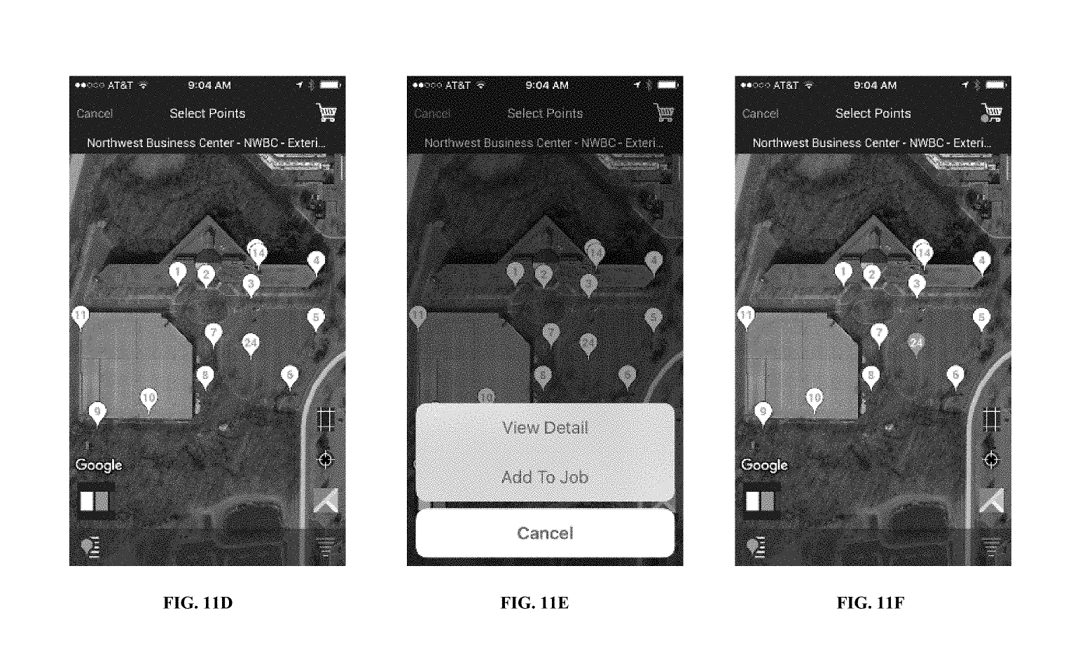

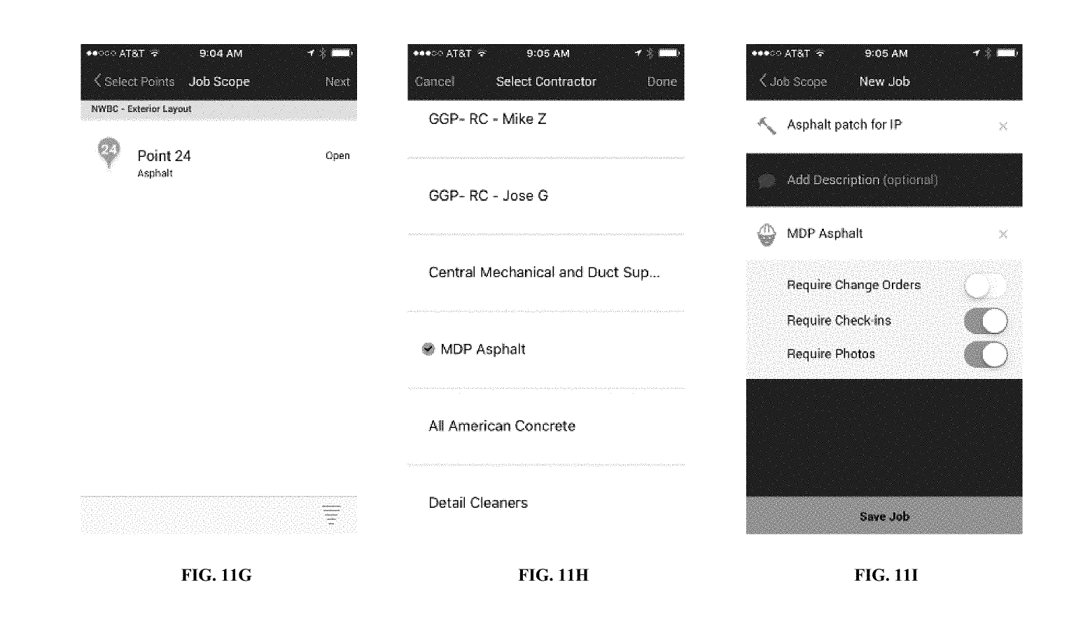

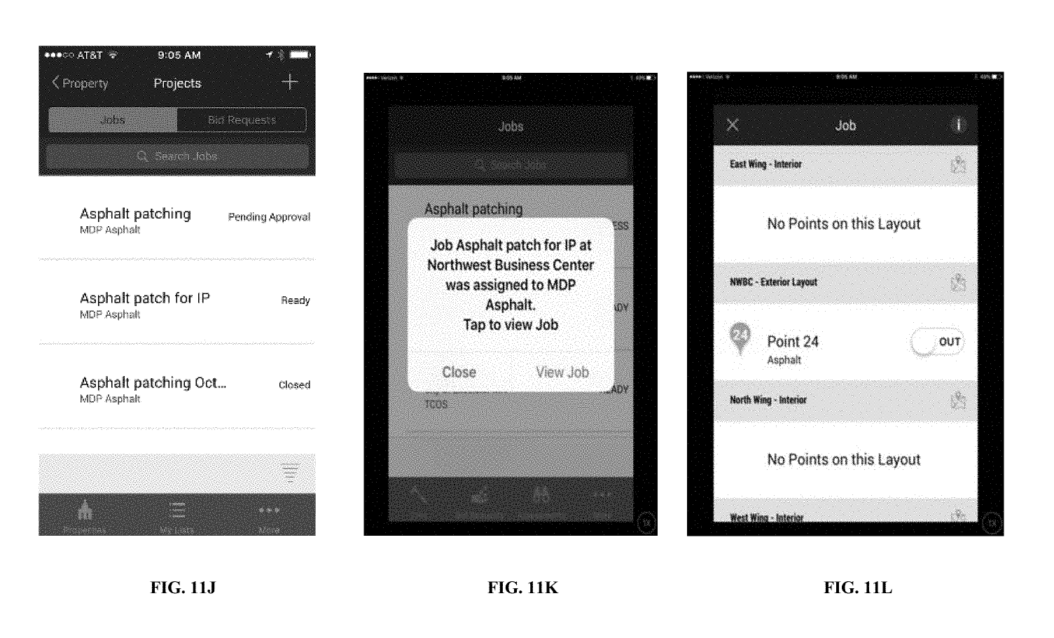

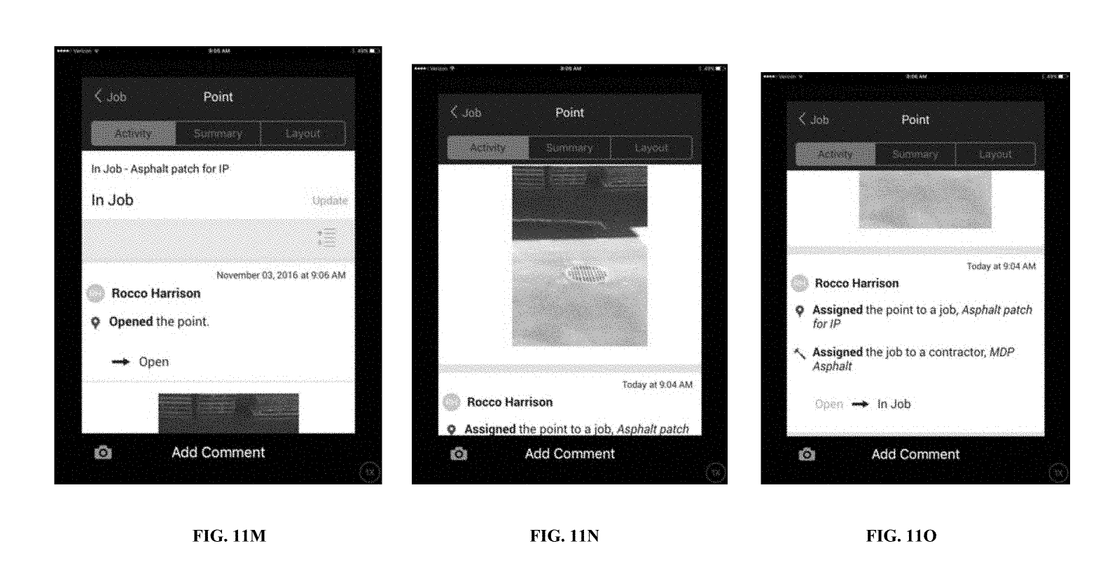

Referring to FIGS. 10A-10X, additional screenshots of a visual filing cabinet system are depicted. In particular, the screenshots depicted the workflow of a property manager walking the property and adding a job, according to an embodiment. For example, referring to FIG. 1 and system 100, the screens shown can be presented by visual interface 120 or data from database 118 on first user device 102 or second user device 104.

In FIG. 10A, a home screen is depicted. In FIG. 10B, after selecting a property, the property manager can add a layout to the property, as depicted in the layout addition screen. In FIG. 10C, layout type options are depicted. Once a layout is selected, the boundaries can be set as depicted in FIG. 10D. In FIG. 10E, the layout can be named. In FIG. 10F, a point is created and placed within the layout. In FIG. 10G, an optional picture of the area is taken. In FIG. 10H, point info is labeled. In FIG. 10I, the layout and point are shown. In FIG. 10J, the property manager can add a job to the property, as depicted in the job addition screen. In FIG. 10K, the property manager is presented with open points to add. In FIG. 10L, the property manager selects the point and confirms it to be added to the job. In FIG. 10M, the point is shown as added to the job. In FIG. 10N, a Job Scope screen confirms all points added to the job. In FIG. 10O, job information can be added to the New Job, such as a title and description. In FIG. 10P, a list of contractors to assign the job can be listed and displayed. In FIG. 10Q, the job can be assigned to a contractor from the contractor list displayed. In FIG. 10R, the job and contractor responsibilities are assigned, such as requiring change orders, requiring check-ins, and requiring photos of the job. In FIG. 105, a job list is depicted. In FIGS. 10T-10V, a point activity stream within the job thread is depicted. In FIGS. 10W-10X, a point summary tab is depicted.

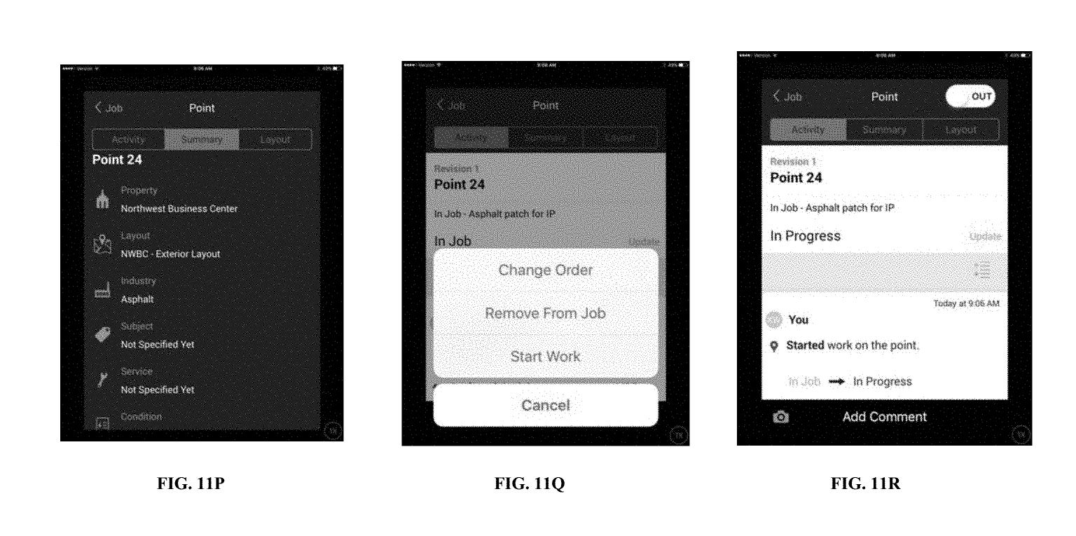

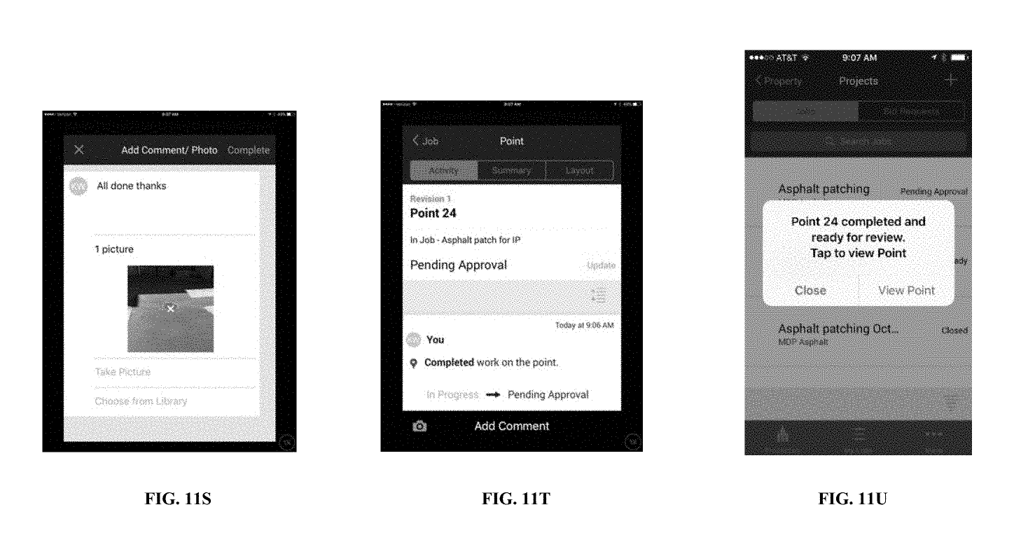

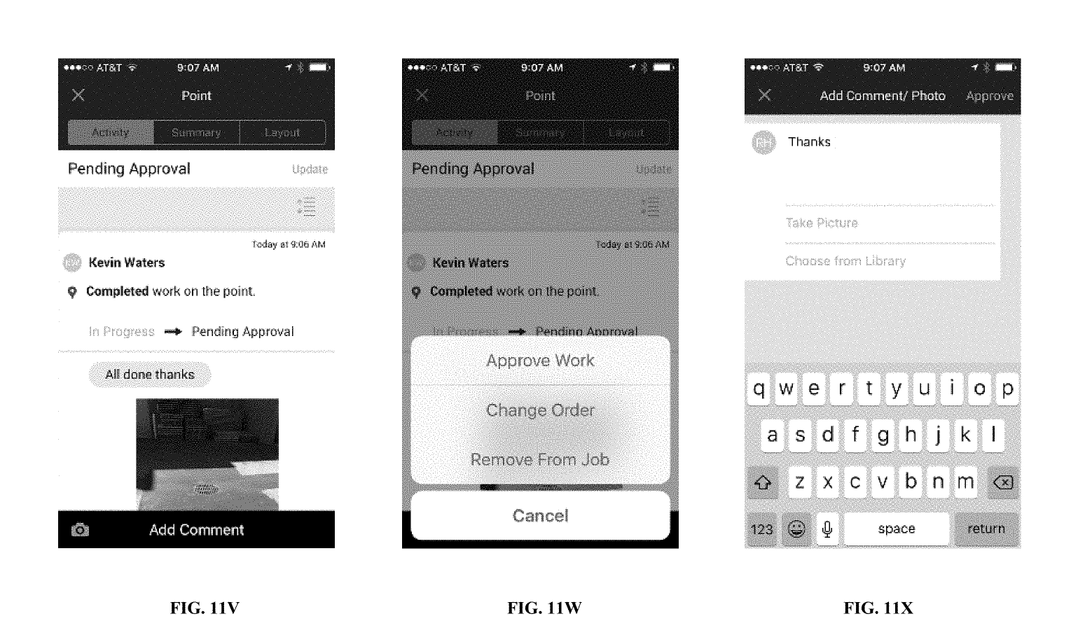

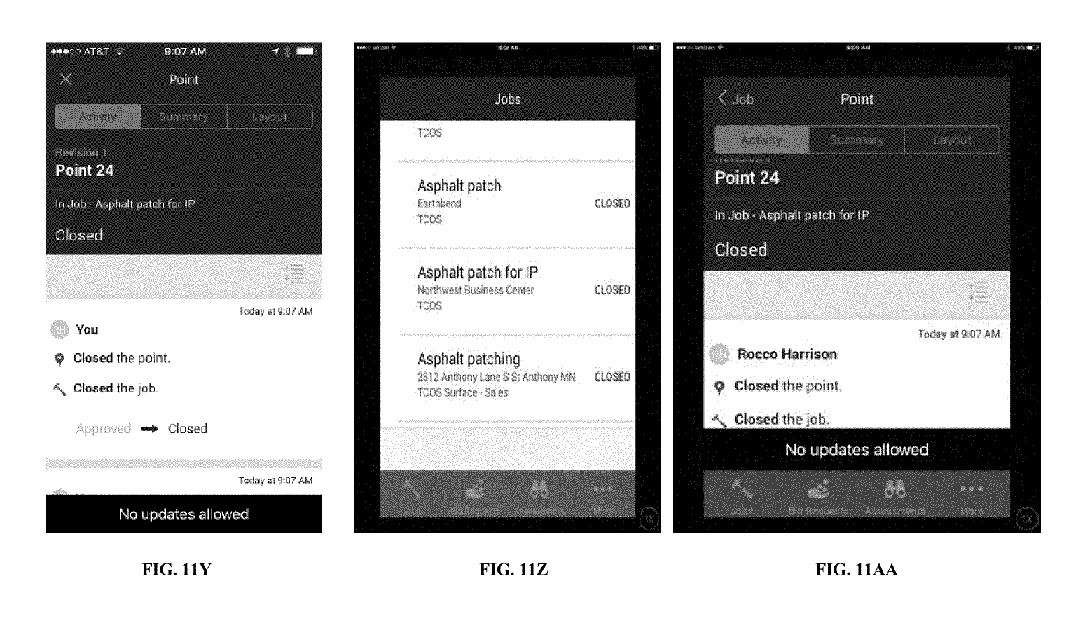

Referring to FIGS. 11A-11AA, screenshots of a visual filing cabinet system for a property manager and contractor interaction workflow are depicted, according to an embodiment. For example, referring to FIG. 1 and system 100, the screens shown can be presented by visual interface 120 or data from database 118 on first user device 102 or second user device 104.

FIGS. 11A-11AA are intended to show a typical workflow of a property manager user of first user device 102 and a contractor user of second user device 104. The workflow is shown by way of example only, and is not limited to the exact screens or flow shown. The following paragraphs switch back and forth between property manager views and contractors views to show the communication flow between the two users and first user device 102 and second user device 104.

For example, referring to FIG. 11A, a property manager can view a layout screen for a property. As shown in FIG. 11A, all of the points on the layout are depicted in a shaded color, such as blue. As depicted, points on a layout can be numbered. Referring to FIG. 11B (contractor-side), a contractor can view all jobs on the job home screen in a list view. The property manager can view all jobs for the property or layout in a list view in the job home screen in FIG. 11C (property manager-side).

Referring to FIG. 11D, a property manager can view open points. Open points can be shaded differently than “all” points. In FIG. 11E, a point can be added to a job by selecting or clicking the point. In FIG. 11F, the layout of FIG. 11A is shown with the point added (in shading) among all open points (no shading). Referring to FIG. 11G, the property manager can confirm the scope of the added point (or a point in the job). In FIG. 11H, the property manager can select a contractor from a list of contractors. Referring to FIG. 11I, the property manager can add job information description or a job title. Referring to FIG. 11J, the job is saved into a list of jobs. For example, jobs given a “ready” status can be sorted or displayed, as can jobs given a “pending approval” status.

Turning to the contractor side, referring to FIG. 11K, a contractor can be presented a notification of the new job. For example, the contractor assigned to the “asphalt patch” job, MDP Asphalt, can be notified or prompted via second user device 104. In embodiments, the prompt is sent by visual filing cabinet 106 after analysis of the communication between first user device 102 and visual filing cabinet 106 (or instruction from first user device 102). From the prompt, the contractor can view the job and job description in FIG. 11L. In FIGS. 11M-110, the contractor can view the point history for the point in the assigned job in the activity stream. In FIG. 11P, the contractor can view the summary tab describing the point. Referring to FIG. 11Q, the contractor can update or start the work and enter that information in the system. In FIG. 11R, the job is noted as in progress. In FIG. 11S, contractor has completed the work and added a picture and comment documenting the work for the point. In FIG. 11T, the contractor can see the job screen is now “pending approval” by the property manager.

Returning to the property manager side, referring to FIG. 11U, the property manager can be presented a notification to approve the work completed by the contractor. In embodiments, the prompt is sent by visual filing cabinet 106 after analysis of the communication between second user device 104 and visual filing cabinet 106 (or instruction from second user device 104). Referring to FIG. 11V, the property manager checks or views the same activity stream thread as the contractor viewed in FIGS. 11M-110 (of course, now having additional data inputted by the contractor). In FIG. 11W, the property manager is able to approve the work, enter a change order, or remove the point from the job. In FIG. 11X, the property manager can add a comment for the contractor about the work while approving the work for that point.

Returning again to the contractor side, referring to FIG. 11Y, the contractor can view the point activity stream and see that the property manager has closed the point. In FIG. 11Z, the contractor job list has been updated to illustrate the closed job. In FIG. 11AA, the contractor can view the closed point.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A system for managing property data, the system comprising:
a visual filing cabinet including computing hardware of at least one processor, memory operably coupled to the at least one processor, and input/output facilities; and
a database communicatively coupled to the visual filing cabinet via the input/output facilities and configured to store property data in a hierarchy-organized container data structure, the container data structure including—
a plurality of property data points,
a property layout-level container configured to store instances of the plurality of property data points, wherein each of the plurality of property data points is based on the property layout-level container, and
a property-level container configured to store an instance of the property layout-level container, wherein the property layout-level container is based on the property-level container,
wherein each of the plurality of property data points comprises data specific to a point of interest based on the property layout-level container and the property-level container;
instructions that, when executed on the visual filing cabinet, cause the computing platform to implement:
a visual interface configured to present access to the hierarchy-organized container data structure to a first user device with the input/output facilities, the access provided to a limited subset of the property data using a graphical user interface and based on at least one temporal characteristic of the property data.

2. The system of claim 1, wherein each of the plurality of property data points is a container configured to store at least two kinds of property data.

3. The system of claim 1, wherein the visual interface is further configured to present access to the hierarchy-organized container data structure to a second user device, wherein the second user device is restricted from access of at least one of the plurality of property data points until the first user device allows access to the hierarchy-organized container data structure.

4. The system of claim 3, wherein the visual interface is configured to present asynchronous access to the hierarchy-organized container data structure for the first user device and the second user device, and wherein the visual interface is configured to present a first interface to the first user device and a second interface to the second user device, the first interface being different from the second interface.

5. The system of claim 1, wherein the container data structure includes a floor plan property layout-level container and a map view property layout-level container, and wherein a first subset of the plurality of property data points are assigned to the floor plan property layout-level container and a second subset of the plurality of property data points are assigned to the map view property layout-level container.

6. The system of claim 5, wherein the visual interface is further configured to present access to the first subset of the plurality of property data points or the second subset of the plurality of property data points based on input from the first user device related to the property layout-level container.

7. The system of claim 1, wherein the visual interface is further configured to receive data to be stored as at least one of the plurality of property data points based on a data capture device of the first user device.

8. A method for managing property data, the method comprising:
providing a visual filing cabinet including computing hardware of at least one processor, memory operably coupled to the at least one processor, and input/output facilities; and
providing a database communicatively coupled to the visual filing cabinet via the input/output facilities and configured to store property data in a hierarchy-organized container data structure, the container data structure including—
a plurality of property data points,
a property layout-level container configured to store instances of the plurality of property data points, wherein each of the plurality of property data points is based on the property layout-level container, and
a property-level container configured to store an instance of the property layout-level container, wherein the property layout-level container is based on the property-level container,
wherein each of the plurality of property data points comprises data specific to a point of interest based on the property layout-level container and the property-level container;
receiving, with the input/output facilities, creation of a point of interest as one of the plurality of property data points from a first user device, the point of interest including at least one temporal characteristic of the property data;
associating the point of interest with a job structure;
receiving, with the input/output facilities, a request to access the job structure from a second user device;
providing access to the point of interest to the second user device with a graphical user interface based on the at least one temporal characteristic of the property data.

9. The method of claim 8, further comprising restricting access to the second user device to the job structure until receiving an indication from the first user device to allow access to the second user device.

10. The method of claim 8, further comprising presenting asynchronous access to the job structure for the first user device and the second user device including—
presenting a first interface to the first user device; and
presenting a second interface to the second user device, the first interface being different from the second interface.

11. The method of claim 8, wherein the container data structure includes a floor plan property layout-level container and a map view property layout-level container, and wherein a first subset of the plurality of property data points are assigned to the floor plan property layout-level container and a second subset of the plurality of property data points are assigned to the map view property layout-level container.

12. The method of claim 11, further comprising presenting access to the first subset of the plurality of property data points or the second subset of the plurality of property data points based on input from the first user device related to the property layout-level container.
